(19) United States
(12) Patent Application Publication
(10) Pub. No.: US 2026/0244053 A1
(43) Pub. Date: Aug. 20, 2026

(54) LIQUID CRYSTAL DEVICE AND METHOD OF FORMING THE SAME

(71) Applicant: Agency for Science, Technology and Research, Singapore (SG)

(72) Inventors: Rasna Maruthiyodan Veetil, Singapore (SG); Ramon Jose Paniagua Dominguez, Singapore (SG); Arseniy Kuznetsov, Singapore (SG)

(21) Appl. No.: 19/164,314

(22) PCT Filed: Feb. 22, 2024
(86) PCT No.: PCT/SG2024/050095

§ 371 Date: Sep. 11, 2025

(30) Foreign Application Priority Data
Mar. 14, 2023 (SG) 10202300705Q

(51) Int. Cl. G02F 1/1343; G02F 1/1335; G02F 1/137

(52) U.S. Cl. CPC G02F 1/134345; G02F 1/133553; G02F 1/13439; G02F 1/137; G02F 2202/36

(57) ABSTRACT

A liquid crystal (LC) device that includes a first electrode. The liquid crystal (LC) device may also include a second electrode. The liquid crystal (LC) device may further include a liquid crystal layer between the first electrode and the second electrode, the liquid crystal layer including liquid crystal molecules and an array of nanostructures adapted to cause a desired alignment of the liquid crystal molecules and to modulate light passing through the liquid crystal device. A periodicity of the array of nanostructures or an aspect ratio of each nanostructure of the array of nanostructures may be adapted to cause the desired alignment of the liquid crystal molecules.

### CROSS-REFERENCE TO RELATED APPLICATION

This application claims the benefit of priority of Singapore application No. 10202300705Q filed Mar. 14, 2023, the contents of it being hereby incorporated by reference in its entirety for all purposes.

### TECHNICAL FIELD

Various embodiments of this disclosure may relate to a liquid crystal device. Various embodiments of this disclosure may relate to a method of forming a liquid crystal device.

### BACKGROUND

The liquid crystal on silicon (LCoS) based spatial light modulator (SLM) is a type of versatile device including one- or two-dimensional array of pixels which is capable of arbitrarily reconfiguring the wavefront of light. FIG. 1A shows a conventional liquid crystal on silicon (LCoS) based spatial light modulator (SLM). These devices use the birefringent properties of liquid crystals (LC) to locally modulate the amplitude, phase, or polarization of light. These devices have applications in engineering, medicine, military, entertainment, communications, education, transport, telecommunications etc. For instance, LCoS SLMs may be used in near-eye devices, augmented reality (AR) systems, virtual reality (VR) systems, three dimensional (3D holographic displays, Light Detection And Ranging (LiDAR) systems, wavelength selective switches (WSS), lithography systems, three dimensional (3D) printing systems etc. Pixel miniaturization of these devices is challenging due to emerging inter-pixel crosstalk, which is the unwanted light modulation in the adjacent pixels to any given one that is purposedly addressed. For phase modulating SLM, the phase delay is accomplished by electrically tuning the orientation of liquid crystal molecules at individual pixel level, which thus changes the refractive index experienced by the light along the propagation path and, in turn controls the phase shift (or retardation). The phase coverage is proportional to the thickness of the LC medium. For the transmissive and reflective SLMs, the LC thickness should be at least λ/Δn and λ/2Δn, respectively, to achieve 2π phase modulation, where Δn is the birefringence of the LC (defined as the difference between the real part of its extraordinary refractive index and ordinary refractive index) and λ is the operational wavelength. The response speed of the device is proportional to the square of the LC thickness under a strong anchoring condition, and varies linearly with LC thickness for weak anchoring. The inter pixel cross talk sets a limit to the minimum pixel size of the device, and is in turn also determined by the LC thickness. Therefore, the LC thickness is a critical parameter in these devices, as it constrains pixel size and response speed, and subsequently the field of view (FOV) and the refresh rate of the device. FIG. 1B shows (above) the relationship between resolution and field of view (FOV), pixel pitch (PP) liquid crystal (LC) layer thickness as well as frame rate; and (below) a comparison of pixel pitch (PP) of devices manufactured by Holoeye and Jasper in years 2000 and 2020.

Integration of a metasurface, i.e., a two dimensional (2D) arrangement of optically resonant elements, also known as nanoantennas, with LC cells forms what is known as a metasurface or nanoantenna spatial light modulator (NSLM). FIG. 1C shows a schematic of a nanoantenna spatial light modulator (NSLM). The NSLM has emerged as a promising platform to miniaturize the pixel size, and have various nano-photonics applications. Unlike in conventional SLMs, abrupt optical phase shifts in NSLMs are introduced by the resonant character of the nanoantenna. The reorientation of LC molecules locally modifies the near-field environment of the nanoantenna, enabling highly efficient spectral tuning of their resonances and the associated phase modulation. Since only the near-field of the nanoantennas needs to be modified (which typically extends only a few hundreds of nanometers at optical frequencies), their presence allows the reduction of the thickness of the tunable medium (i.e., the LC layer) significantly. The cross-talk between neighboring electrodes is also reduced, thereby allowing pixel miniaturization. This allows for wavefront modulating devices with a wide field of view and an improved refreshing rate. Typically, the NSLM devices have miniaturized LC cells (each with thickness of less than 1 μm).

However, for such thin cells, a problem arises if one uses the common strategy to induce the pre-alignment of the LC by using an alignment layer, such as a polyimide layer for rubbed alignment or a suitable photosensitive material layer for photo-induced alignment. For ultra-thin cells, the dielectric shielding effect would be apparent even with a thin alignment layer and the effective phase shift would be reduced. Further, the strong anchoring from the alignment layer for an ultra-thin LC cell slows down the electric field response of the LC and increases the range of volage level required for switching which may increase again the cross-talk, ultimately hindering the benefit of using thinner cells.

### SUMMARY

Various embodiments may relate to a liquid crystal (LC) device. The liquid crystal (LC) device may include a first electrode. The liquid crystal (LC) device may also include a second electrode. The liquid crystal (LC) device may further include a liquid crystal layer between the first electrode and the second electrode, the liquid crystal layer including liquid crystal molecules and an array of nanostructures adapted to cause a desired alignment of the liquid crystal molecules and to modulate light passing through the liquid crystal device. A periodicity of the array of nanostructures or an aspect ratio of each nanostructure of the array of nanostructures may be adapted to cause the desired alignment of the liquid crystal molecules.

Various embodiments may relate to a method of forming a liquid crystal (LC) device. The method may include forming a first electrode. The method may also include forming a second electrode. The method may further include forming a liquid crystal layer between the first electrode and the second electrode, the liquid crystal layer including liquid crystal molecules and an array of nanostructures adapted to cause a desired alignment of the liquid crystal molecules and to modulate light passing through the liquid crystal device. A periodicity of the array of nanostructures or an aspect ratio of each nanostructure of the array of nanostructures may be adapted to cause the desired alignment of the liquid crystal molecules.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1A shows a conventional liquid crystal on silicon (LCoS) based spatial light modulator (SLM).

FIG. 1B shows (above) the relationship between resolution and field of view (FOV), pixel pitch (PP) liquid crystal (LC) layer thickness as well as frame rate; and (below) a comparison of pixel pitch (PP) of devices manufactured by Holoeye and Jasper in years 2000 and 2020.

FIG. 1C shows a schematic of a nanoantenna spatial light modulator (NSLM). The NSLM has emerged as a promising platform to miniaturize the pixel size, and have various nano-photonics applications.

FIG. 2 shows a general illustration of a liquid crystal (LC) device according to various embodiments.

FIG. 3 shows a general illustration of a method of forming a liquid crystal (LC) device according to various embodiments.

FIG. 4A shows a schematic of a cross-sectional side view of a unit cell of a conventional transmissive nanoantenna spatial light modulator (NSLM) with disc shaped nanoantennas.

FIG. 4B shows a schematic illustrating the orientation of a liquid crystal (LC) molecule used in the LC device according to various embodiments.

FIG. 5 shows a schematic of a cross-sectional side view of a unit cell of an ultra-thin liquid crystal (LC) device with disc shaped nanoantennas and without a top electrode alignment layer.

FIG. 6 shows a schematic of a cross-sectional side view of a unit cell of another ultra-thin liquid crystal (LC) device with square shaped nanoantennas 608 and without a top electrode alignment layer.

FIG. 7 shows the scanning electron microscopy (SEM) images of (a) an array of disc shaped nanoantennas and (b) an array of square shaped nanoantennas.

FIG. 8A shows a simulated plot of transmittance as a function of wavelength (in nanometers or nm) illustrating the transmission spectrum of the liquid device (LC) with the disc shaped nanoantennas as shown in FIG. 5 under illumination of normally incident light with polarizations along X-axis (P-0, solid line), along Y-axis (P-90, dotted line) and at an angle of 45° to the X-axis (P-45, dashed line).

FIG. 8B shows a measured plot of transmittance as a function of wavelength (in nanometers or nm) illustrating the transmission spectrum of the liquid crystal (LC) devices with 1500 nm thick liquid crystal (LC) layers as well as disc shaped nanoantennas arrays, and having an alignment layer (W, dashed line) or without an alignment layer (WO, solid line), under incident light with polarization along the X-axis, with the insets showing microscopic images of the cell without an alignment layer (WO) and with an alignment layer (W) under crossed polarizer (Pₓ) and analyzer (A_{y}).

FIG. 8C shows a measured plot of transmittance as a function of wavelength (in nanometers or nm) illustrating the transmission spectrum of the liquid crystal (LC) devices with 1500 nm thick liquid crystal (LC) layers as well as disc shaped nanoantennas arrays, and having a top electrode alignment layer (W, dashed line) or without a top electrode alignment layer (WO, solid line), under incident light with polarization 135° to the X-axis, with the insets showing microscopic images of the cells without an alignment layer (WO) and with an alignment layer (W) under crossed polarizer (Pₓ) and analyzer (A_{y}).

FIG. 8D shows a measured plot of transmittance as a function of wavelength (in nanometers or nm) illustrating the transmission spectrum of the liquid crystal (LC) devices with 750 nm thick liquid crystal (LC) layers as well as disc shaped nanoantennas arrays, and having an alignment layer (W, dashed line) or without an alignment layer (WO, solid line), under incident light with polarization along the X-axis, with the insets showing microscopic images of the cell without an alignment layer (WO) and with an alignment layer (W) under crossed polarizer (Pₓ) and analyzer (A_{y}).

FIG. 8E shows a measured plot of transmittance as a function of wavelength (in nanometers or nm) illustrating the transmission spectrum of the liquid crystal (LC) devices with 750 nm thick liquid crystal (LC) layers as well as disc shaped nanoantennas arrays, and having a top electrode alignment layer (W, dashed line) or without a top electrode alignment layer (WO, solid line), under incident light with polarization 45° to the X-axis, with the insets showing microscopic images of the cells without an alignment layer (WO) and with an alignment layer (W) under crossed polarizer (Pₓ) and analyzer (A_{y}).

FIG. 9A shows a simulated plot of transmittance as a function of wavelength (in nanometers or nm) illustrating the transmission spectrum of the liquid device (LC) with the square shaped nanoantennas as shown in FIG. 6 under illumination of normally incident light with polarizations along X-axis, along Y-axis and at an angle of 45° to the X-axis.

FIG. 9B shows a plot of transmittance as a function of wavelength (in nanometers or nm) shows a measured plot of transmittance as a function of wavelength (in nanometers or nm) illustrating the transmission spectrum of the liquid crystal (LC) devices with 750 nm thick liquid crystal (LC) layers as well as square nanoantennas arrays, and having an alignment layer (rubbing direction along the X-axis) for applied voltages of 0Vᵣₘₛ and 4Vᵣₘₛ under incident light with polarization P-135 and for applied voltage of 0Vᵣₘₛ, under incident light with polarization P-0 and incident light with polarization P-45, with the insets showing microscopic images of the cells with parallel orientation and 45° orientation under crossed polarizer (Pₓ) and analyzer (A_{y}).

FIG. 9C shows a plot of transmittance as a function of wavelength (in nanometers or nm) shows a measured plot of transmittance as a function of wavelength (in nanometers or nm) illustrating the transmission spectrum of the liquid crystal (LC) devices with 750 nm thick liquid crystal (LC) layers as well as square nanoantennas, without an alignment layer for applied voltages of 0Vᵣₘₛ and 4Vᵣₘₛ under incident light with polarization P-45 and for applied voltage of 0Vᵣₘₛ, under incident light with polarization P-0 and incident light with polarization P-135, with the insets showing microscopic images of the cells with parallel orientation and 45° orientation under crossed polarizer (Pₓ) and analyzer (A_{y}).

FIG. 10 shows a schematic of a liquid crystal (LC) alignment induced by the nanostructures or nanoantennas having (a, b) shape of discs and (c, d) shape of squares.

FIG. 11 shows a schematic of a cross-sectional side view of a unit cell of an ultra-thin liquid crystal (LC) device according to various embodiments.

FIG. 12 shows (a) a scanning electron microscopy (SEM) image of fabricated rectangular nanoantenna metasurface according to various embodiments; and (b) a schematic illustrating the alignment of the liquid crystal molecules induced by the rectangular nanostructures or nanoantennas according to various embodiments.

FIG. 13A shows a simulated plot of transmittance as a function of wavelength (in nanometers or nm) illustrating the transmission spectrum of the liquid device (LC) with the rectangular nanoantennas according to various embodiments as shown in FIG. 11 under illumination of normally incident light with polarizations along X-axis (P-0, dashed line) and along Y-axis (P-90, solid line).

FIG. 13B shows a measured plot of transmittance as a function of wavelength (in nanometers or nm) illustrating the transmission spectrum of the liquid device (LC) with the rectangular nanoantennas according to various embodiments as shown in FIG. 11 under illumination of normally incident light with polarizations along X-axis (P-0, dashed line) and along Y-axis (P-90, solid line).

FIG. 14 shows (a) scanning electron microscopy (SEM) images of fabricated nano-square nanoantennas (L=W=270 nm, H=200 nm, Pₓ=P_{y}=360 nm); (b)-(d) microscopy images of the fabricated square nanoantennas shown in (a) under crossed polarizer (Pₓ) and analyzer (A_{y}) for different array orientations; (e) scanning electron microscopy (SEM) images of fabricated rectangular nanoantennas according to various embodiments (L=260 nm, W=180 nm, H=200 nm, Pₓ=360 nm, P_{y}=290 nm) ; (f)-(h) microscopy images of the fabricated rectangular nanoantennas shown in (e) according to various embodiments under crossed polarizer (Pₓ) and analyzer (A_{y}) for different array orientations; (i) scanning electron microscopy (SEM) images of fabricated rectangular nanoantennas according to various embodiments (L=350 nm, W=180 nm, H=200 nm, Pₓ=430 nm, P_{y}=270 nm) ; (j)-(1) microscopy images of the fabricated rectangular nanoantennas shown in (i) according to various embodiments under crossed polarizer (Pₓ) and analyzer (A_{y}) for different array orientations.

FIG. 15A shows a simulated plot of transmittance as a function of wavelength (in nanometers or nm) illustrating the transmission spectrum of the liquid device (LC) with the rectangular nanoantennas for homogeneous (θ=90°, solid line) liquid crystal (LC) alignment and for homeotropic (θ=0°, dashed line) liquid crystal (LC) alignment under incident light with polarization along the X-axis (P-0) according to various embodiments.

FIG. 15B shows a measured plot of transmittance as a function of wavelength (in nanometers or nm) illustrating the transmission spectrum of the liquid device (LC) with the rectangular nanoantennas and without an alignment layer for applied voltages 0Vᵣₘₛ, 3.5Vᵣₘₛ and 5Vᵣₘₛ under incident light with polarization along the X-axis (P-0) according to various embodiments. FIG. 15C shows a measured plot of transmittance as a function of wavelength (in nanometers or nm) illustrating the transmission spectrum of the liquid device (LC) with the rectangular nanoantennas and with an alignment layer for applied voltages 0Vᵣₘₛ, 3.5Vᵣₘₛ and 5Vᵣₘₛ under incident light with polarization along the X-axis (P-0).

FIG. 16 shows microscopy images of liquid crystal (LC) infiltrated rectangular nanoantennas under crossed polarizer (Pₓ) and Analyzer (A_{y}) for (a)-(c) 500 nm thick liquid crystal (LC) cell with top electrode alignment layer under different applied voltages; (d)-(f) 500 nm thick liquid crystal (LC) cell with pure metasurface induced alignment without top electrode alignment layer according to various embodiments under different applied voltages; and (h)-(j) 1000 nm thick liquid crystal (LC) cell with pure metasurface induced alignment without top electrode alignment layer according to various embodiments under different applied voltages. One set of arrows indicate the LC director which is orientated along the length or long axis of the rectangular nanoantennas, while another set of arrows indicate the alignment direction induced by the top electrode alignment layer.

FIG. 17A shows a plot of waveform (in volts or V)/ intensity as a function of time (in milliseconds or ms) illustrating the switch performance (voltage dependent transmitted intensity-black dotted line) of a 1000 nm thick cell without alignment layer according to various embodiments under applied signals (grey lines).

FIG. 17B shows a plot of waveform (in volts or V)/ intensity as a function of time (in milliseconds or ms) illustrating the switch performance (voltage dependent transmitted intensity-black dotted line) of a 750 nm thick cell without alignment layer according to various embodiments under applied signals (grey lines).

FIG. 17C shows a plot of waveform (in volts or V)/ intensity as a function of time (in milliseconds or ms) illustrating the switch performance (voltage dependent transmitted intensity-black dotted line) of a 750 nm thick cell with a top electrode alignment layer under applied signals (grey lines).

FIG. 18 shows a schematic of a cross-sectional side view of a unit cell of a liquid crystal (LC) device with rectangular nanoantennas according to various embodiments.

FIG. 19 shows a schematic of a perspective view of a unit cell of a liquid crystal (LC) device with rectangular nanoantennas and a pixelated second electrode according to various embodiments.

FIG. 20 shows a schematic of a cross-sectional side view of a unit cell of a transmissive liquid crystal (LC) device with rectangular nanoantennas on or in contact with the first electrode and the second electrode respectively according to various embodiments.

FIG. 21 shows a schematic of a cross-sectional side view of a unit cell of a reflective liquid crystal (LC) device with rectangular nanoantennas on opposing sides on a liquid crystal layer according to various embodiments.

FIG. 22 shows a schematic of a cross-sectional side view of a unit cell of a liquid crystal (LC) device with two arrays of rectangular nanoantennas aligned perpendicular to each other according to various embodiments.

FIG. 23 shows a schematic of a cross-sectional side view of a unit cell of a transmissive liquid crystal (LC) device with an array of nanopillars according to various embodiments.

FIG. 24 shows a schematic of a cross-sectional side view of a unit cell of a reflective liquid crystal (LC) device with an array of nanopillars according to various embodiments.

FIG. 25A shows a schematic of a cross-sectional side view of a unit cell of a reflective liquid crystal (LC) device with an array of nanopillars according to various embodiments when the voltage applied is below the threshold voltage (Vₜₕ).

FIG. 25B shows a schematic of a cross-sectional side view of the unit cell of the reflective liquid crystal (LC) device with the array of nanopillars according to various embodiments when the voltage applied is above the threshold voltage (Vₜₕ).

FIG. 26 shows a table comparing the liquid crystal (LC) device according to various embodiments with previous devices that have been reported.

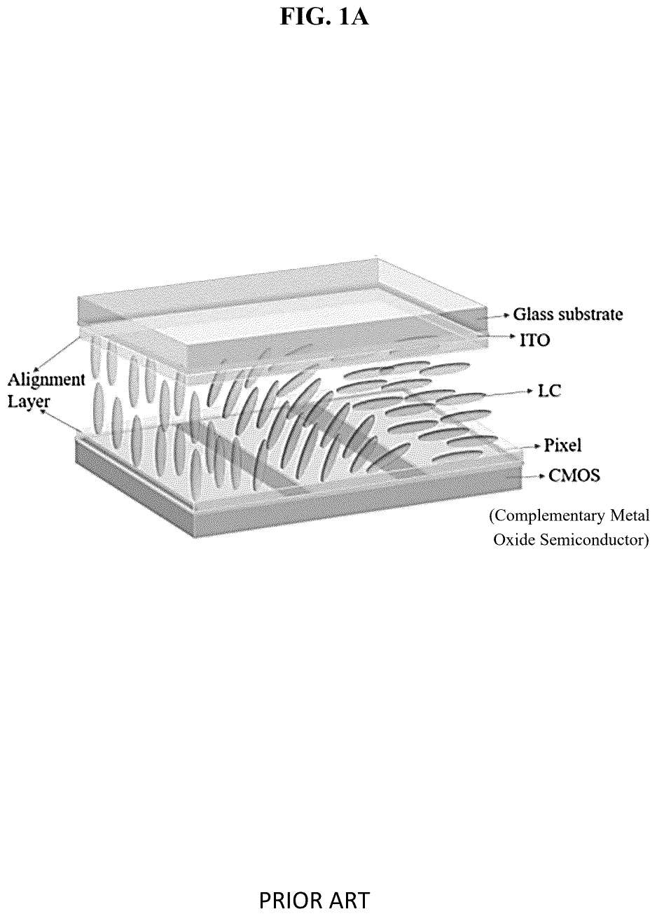

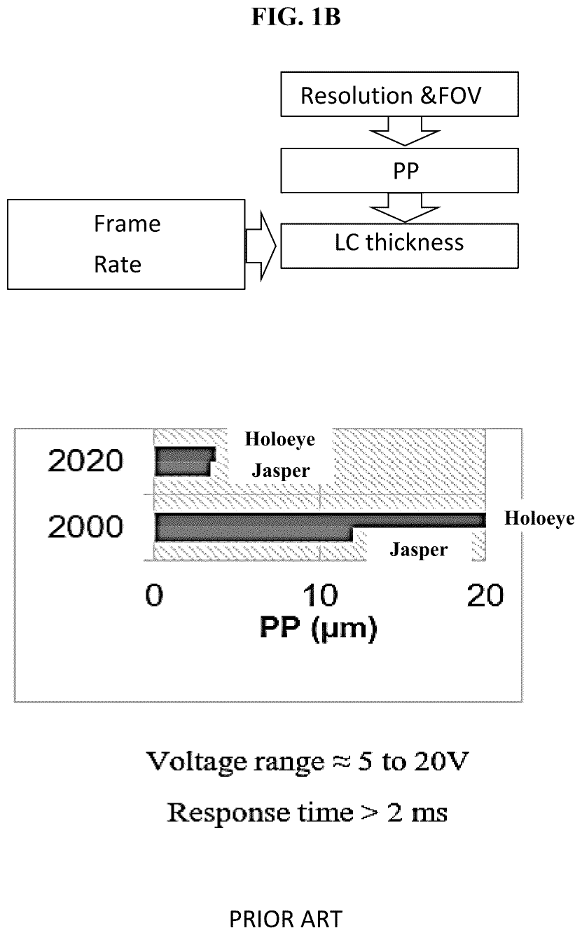

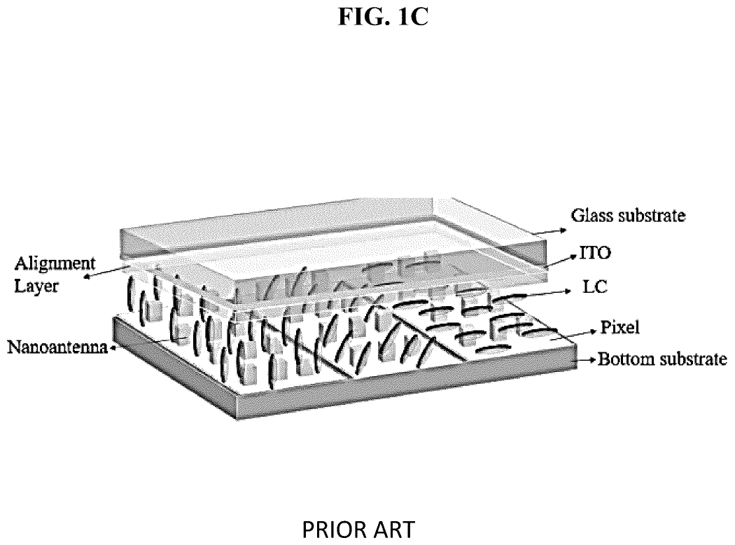

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance, e.g. within 10% of the specified value.

As used herein, the term “and/or” includes any and all combinations of one or more of the associated listed items.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

Embodiments described in the context of one of the liquid crystal devices are analogously valid for the other liquid crystal devices, embodiments described in the context of a method are analogously valid for a liquid crystal devices, and vice versa.

Various embodiments may address one or more issues faced by conventional devices. Various embodiments may provide a liquid crystal (LC) alignment strategy different from that of conventional devices. Various embodiments may not include a separate alignment layer. Instead, the metasurface or array of nanoantennas (referred to also as nanostructures) may provide alignment (i.e., pre-alignment) for the liquid crystal (LC) molecules. According to various embodiments, the nanostructures may have a dual purpose of sustaining optical resonances used for light modulation and inducing the required alignment of liquid crystal (LC) molecules. The LC molecular alignment may be purely controlled by the periodicity and geometry of the nanoantennas without any additional alignment layer. Various embodiments may have greatly reduced response time and operational voltage requirements.

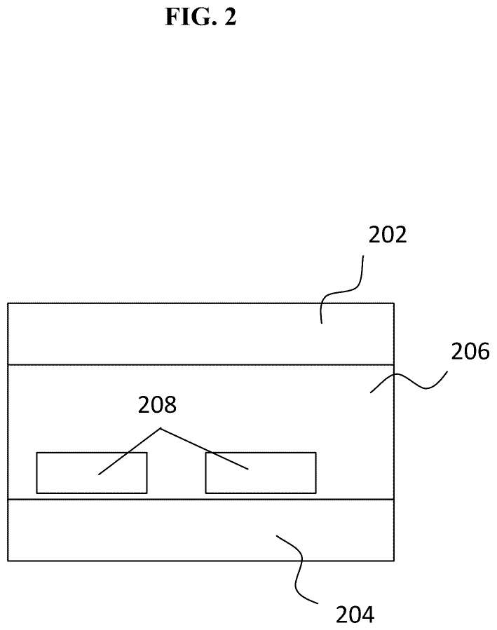

FIG. 2 shows a general illustration of a liquid crystal (LC) device according to various embodiments. The device may be referred to as a metasurface-LC device, a metasurface or nanoantenna spatial light modulator (NSLM), or more simply as a spatial light modulator (SLM). The liquid crystal (LC) device may include a first electrode 202. The liquid crystal (LC) device may also include a second electrode 204. The liquid crystal (LC) device may further include a liquid crystal layer 206 between or sandwiched between the first electrode 202 and the second electrode 204, the liquid crystal layer 206 including liquid crystal molecules and an array of nanostructures 208 adapted to cause a desired alignment of the liquid crystal molecules and to modulate light passing through the liquid crystal device. A periodicity of the array of nanostructures and/or an aspect ratio of each nanostructure of the array of nanostructures may be adapted to cause the desired alignment of the liquid crystal molecules.

In other words, various embodiments may include two electrodes 202, 204 and a liquid crystal layer 206 between the two electrodes 202, 204. The liquid crystal layer 206 may have nanostructures or nanoantennas which have a dual function of modulating light as well as to provide alignment (i.e., pre-alignment) for the liquid crystal molecules of the liquid crystal layer 206.

For avoidance of doubt, FIG. 2 is intended to illustrate some features of the device according to various embodiments, and is not intended to limit the size, shape, orientation, arrangement etc. of the various embodiments. For instance, while FIG. 2 shows the nanostructures 208 having rectangular cross-sectional shapes, it is envisioned that the nanostructures 208 may have other suitable cross-sectional shapes, e.g. elliptical or ellipsoidal shapes. In addition, while FIG. 2 shows two nanostructures, various embodiments may include any suitable number of nanostructures.

The periodicity of the array of nanostructures and/or the aspect ratio of each of the array of nanostructures may be adapted to cause/control the alignment of the liquid crystal molecules so that the liquid crystal molecules are aligned in a desired direction/alignment. This can be achieved without the use of an alignment layer support in the liquid crystal device. The presence of an alignment layer in the device may increase the voltage requirement for resonance tuning and may reduce the efficiency of light modulation. The presence of an alignment layer may also constrain a device's thickness, its switching speed and device sensitivity. This may be even more pronounced for an ultra-thin liquid crystal device (e.g. where the thickness of the liquid crystal layer is of sub-micron scale). These effects of the alignment layer in a liquid crystal device may be undesirable. Various embodiments may therefore use an array of nanostructures or nano-antennas to achieve a desired alignment of the liquid crystal molecules and to modulate light passing through the liquid crystal device without the use of an alignment layer.

In various embodiments, the array of nanostructures 208 may be arranged in a periodic lattice.

In various embodiments, the second electrode 204 may or may not be pixelated.

In various embodiments, wherein the first electrode 202 may be continuous and the second electrode 204 may be pixelated. The array of nanostructures 208 may be formed on the first electrode 202 or the second electrode 204. In other words, the array of nanostructures 208 may be in contact with the first electrode 202 or the second electrode 204. In various embodiments, each pixel of the pixelated second electrode 204 may be configured to be addressed individually by an integrated circuit. The nanoantennas or nanostructures 208 on the pixelated second electrode 204 may provide higher device efficiency as compared to a non-pixelated electrode. In various other embodiments, the nanostructures 208 may be located on or in contact with the first continuous electrode 202.

In various embodiments where the first electrode 202 is additionally or alternatively pixelated, the first electrode 202 may be configured to be addressed individually by an integrated circuit.

In various embodiments, the liquid crystal layer 206 may further include a further array of nanostructures. The array of nanostructures 208 and the further array of nanostructures may be at opposing sides of the liquid crystal layer 206. In various embodiments, the array of nanostructures 208 may be in contact with the second electrode 204 and the further array of nanostructures may be in contact with first electrode 202, or vice versa. In various embodiments, a longitudinal axis of the array of nanostructures 208 may be rotated with respect to a longitudinal axis of the further array of nanostructures. The longitudinal axis of the array of nanostructures 208 may be rotated at an angle greater than 0° with respect to the longitudinal axis of the further array of nanostructures.

In various embodiments, the longitudinal axis of the array of nanostructures 208 may be substantially perpendicular to the longitudinal axis of the array of nanostructures 208. For instance, the longitudinal axis of the array of nanostructures 208 may be any one value selected from a range from 80° to 110°, e.g. 85° to 105°, to the longitudinal axis of the array of nanostructures 208. In various embodiments, the longitudinal axis of the array of nanostructures 208 may be perpendicular to the longitudinal axis of the array of nanostructures 208.

In various embodiments, the first electrode 202 and the second electrode 204 may be transparent. In various embodiments, the first electrode 202 and the second electrode 204 may each allow a substantial amount of light (e.g. more than 80%, more than 90%, more than 95% or more than 99%) having any one wavelength or range of wavelengths selected from a range from 400 nm to 1500 nm to pass through. The first electrode 202 and the second electrode 204 may include any suitable transparent material such as indium tin oxide (ITO), gallium doped ITO, fluorine doped tin oxide (FTO), doped zinc oxide, aluminum doped zin oxide (AZO), carbon nanotubes or graphene.

In various embodiments, the first electrode 202 may be transparent and the second electrode 204 may be reflective. In various embodiments, the first electrode 202 may allow a substantial amount of light (e.g. more than 80%, more than 90%, more than 95% or more than 99%) having any one wavelength or range of wavelengths selected from a range from 400 nm to 700 nm to pass through. The second electrode 204 may reflect a substantial amount of light (e.g. e.g. more than 80%, more than 90%, more than 95% or more than 99%) having any one wavelength or range of wavelengths selected from a range from 400 nm to 1500 nm. In various embodiments, the second electrode 204 may include an aluminum layer, a gold layer, a silver layer, or a copper layer. In various other embodiments, the second electrode 204 may include a dielectric mirror in combination with a transparent electrical conductor. On the other hand, the first electrode 202 may include any suitable transparent material such as indium tin oxide (ITO), gallium doped ITO, fluorine doped tin oxide (FTO), doped zinc oxide, aluminum doped zin oxide (AZO), carbon nanotubes or graphene.

In various embodiments, a thickness of the liquid crystal layer 206 may be of any one value selected from a range from 200 nm to 800 nm. In various embodiments, a distance between the first electrode 202 and the second electrode 204 may be of any one value selected from a range from 200 nm to 800 nm. The minimal thickness of the liquid crystal layer 206 may be equivalent to a height of the nanostructures/nano-antennas, which may be any one value selected from a range from 200 nm to 800 nm.

In various embodiments, the array of nanostructures 208 and/or the further array of nanostructures may have at least two dimensions smaller than an operating light wavelength of the liquid crystal device. In various embodiments, one, two or all three dimensions of each nanostructure of the array of nanostructures 208 or the further array of nanostructures may be of any value less than 700 nm, or less than 500 nm, or less than 400 nm or less than 100 nm.

In various embodiments, the array of nanostructures 208 and/or the further array of nanostructures may include a dielectric material or a semiconductor material. In various embodiments, the array of nanostructures 208 and/or the further array of nanostructures may be made of a dielectric material or a semiconductor material which has a real part of a refractive index being more than or equal to 2, and an imaginary part of the refractive index being less than or equal to 0.1. In various embodiments, the dielectric material may be or may include titanium oxide (TiO₂). In various embodiments, the array of nanostructures 208 and/or the further array of nanostructures may include titanium oxide, silicon, germanium, gallium nitride, gallium phosphide, indium phosphide, gallium arsenide, silicon nitride, or copper oxide.

In various embodiments, the liquid crystal (LC) molecules may be any suitable molecules. For instance, the liquid crystal molecules may be or may include nematic liquid crystal molecules, dual frequency liquid crystal (DFLC) molecules, smectic liquid crystal molecules, or chiral liquid crystal molecules.

In various embodiments, a dimension along a direction at which the liquid crystal (LC) molecules are to be aligned of each nanostructure of the array of nanostructures may be larger compared to remaining dimensions of the nanostructure. In other words, a dimension of each of the first array of nanostructures may be adapted to be the largest along a direction at which the liquid crystal molecules are to be aligned. The dimension of the nanostructure along this alignment direction of the LC molecules may be more than 0%, more than 10%, more than 20%, more than 30%, more than 50%, more than 100%, more than 200%, more than 300%, or more than 500% than each of the remaining dimensions of the nanostructure. In various embodiments, an aspect ratio (AR) of a nanostructure (e.g. indicating the ratio of a dimension of the nanostructure along the direction at which the liquid crystal (LC) molecules are to be aligned to a dimension perpendicular to the direction (at which the liquid crystal (LC) molecules are to be aligned)) may for instance be more than 1:1, more than 1.1:1, more than 1.2:1, more than 1.3:1, more than 1.5:1, more than 2:1, more than 3:1 more than 4:1, or more than 6:1.

In various embodiments, a periodic lattice of the array of nanostructures may include a longest lattice vector along a direction at which the liquid crystal molecules are to be aligned. In other words, a lattice vector of the periodic lattice of the array of nanostructures may be longer than other lattice vectors of the periodic lattice. The lattice vector along this alignment direction of the LC molecules may be more than 0%, more than 10%, more than 20%, more than 30%, more than 50% more than 100%, more than 200%, more than 300%, or more than 500% than each of the remaining lattice vectors.

In various embodiments, a threshold voltage or potential difference applied between the first electrode 202 and the second electrode 204 for switching the liquid crystal device may be of any one value selected from a range from 0.5Vᵣₘₛ to 0.8Vᵣₘₛ. Vᵣₘₛ represents the root-mean square voltage. The applied voltage may be an alternating voltage or alternating current (AC) voltage.

In various embodiments, the liquid crystal device may further include a passivation layer formed on the second electrode 204 adapted to avoid direct contact of the liquid crystal molecules with the second electrode 204. The first electrode 202 may be in contact with the liquid crystal layer 206. The passivation layer may include an oxide having a refractive index of less than 2 and may be transparent. The oxide may, for instance, be silicon oxide, germanium oxide or aluminum oxide.

In various other embodiments, both the first electrode 202 and the second electrode 204 may be in contact with the liquid crystal layer 206. In yet various other embodiments, both the first electrode 202 and the second electrode 204 may not be in contact with the liquid crystal layer 206.

In various embodiments, the array of nanostructures may include nanopillars, each of the nanopillars having a height which is larger than its width or its length. Each of the nanopillars may include one or more materials. The nanopillars may be adapted to align the liquid crystal molecules in a direction along a longitudinal axis of the nanopillars. The liquid crystal molecules may include positive dielectric anisotropy. Switching of the liquid crystal device may be provided by an application of an in-plane electric field across the nanopillars. The in-plane electric field may be an external electric field provided by a complementary metal oxide semiconductor (CMOS) device or circuit.

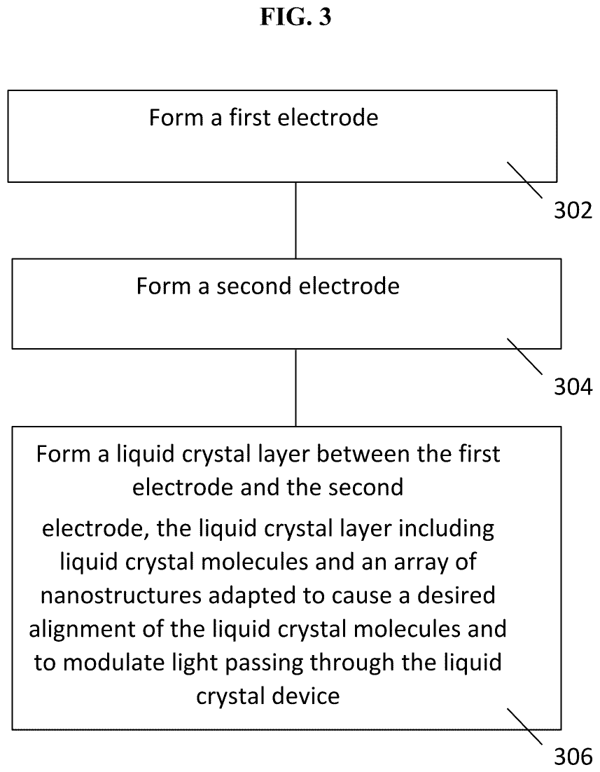

FIG. 3 shows a general illustration of a method of forming a liquid crystal (LC) device according to various embodiments. The method may include, in 302, forming a first electrode. The method may also include, in 304, forming a second electrode. The method may further include, in 306, forming a liquid crystal layer between the first electrode and the second electrode, the liquid crystal layer including liquid crystal molecules and an array of nanostructures adapted to cause a desired alignment of the liquid crystal molecules and to modulate light passing through the liquid crystal device. A periodicity of the array of nanostructures or/and an aspect ratio of each nanostructure of the array of nanostructures may be adapted to cause the desired alignment of the liquid crystal molecules.

In other words, the method of forming a LC device may include forming the two electrodes and the liquid crystal layer between the two electrodes. The liquid crystal layer may include liquid crystal molecules as well as an array of nanostructures designed to align the liquid crystal molecules and also to modulate light.

For avoidance of doubt, FIG. 3 is not intended to limit the sequence of the various steps. For instance, step 302 may occur before or after step 304. In various embodiments, the second electrode may be formed first, followed by forming the liquid crystal layer (with the array of nanostructures) over the second electrode, and then forming the first electrode over the liquid crystal layer. In various other embodiments, the first electrode may be formed first, followed by forming the liquid crystal layer (with the array of nanostructures) over the first electrode, and then forming the second electrode over the liquid crystal layer.

In various embodiments, the second electrode may be pixelated, while in various other embodiments, the second electrode may be continuous. In various embodiments, the first electrode may be pixelated, while in various other embodiments, the first electrode may be continuous.

In various embodiments, the liquid crystal layer may include a further array of nanostructures. The array of nanostructures and the further array of nanostructures may be at opposing sides of the liquid crystal layer. In various embodiments, the array of nanostructures may be in contact with the second electrode and the further array of nanostructures may be in contact with first electrode. In various other embodiments, the array of nanostructures may be in contact with the first electrode and the further array of nanostructures may be in contact with second electrode.

In various embodiments, a longitudinal axis of the array of nanostructures may be rotated with respect to a longitudinal axis of the further array of nanostructures. In various embodiments, the longitudinal axis of the array of nanostructures is substantially perpendicular to the longitudinal axis of the further array of nanostructures.

In various embodiments, the second electrode may be transparent. In various other embodiments, the second electrode may be reflective.

In various embodiments, the first electrode may be transparent. In various other embodiments, the first electrode may be reflective.

In various embodiments, a thickness of the liquid crystal layer may be of any one value selected from a range from 200 nm to 800 nm.

In various embodiments, the array of nanostructures may have at least two dimensions smaller than an operating light wavelength of the liquid crystal device.

In various embodiments, a dimension along a direction at which the liquid crystal molecules are to be aligned of each nanostructure of the array of nanostructures may be larger compared to remaining dimensions of the nanostructure. In various embodiments, a periodic lattice of the array of nanostructures comprises a longest lattice vector along a direction at which the liquid crystal molecules are to be aligned.

In various embodiments, the method may further include forming a passivation layer formed on the second electrode adapted to avoid direct contact of the liquid crystal molecules with the second electrode. The passivation layer may include an oxide having a refractive index of less than 2 and may be transparent.

In various embodiments, the array of nanostructures may include nanopillars, each of the nanopillars having a height which is larger than its width or its length.

Various embodiments may provide an ultra-thin metasurface-LC cell, where the metasurface (i.e., formed by the nanostructures or nanoantennas) defines the LC alignment without need of an additional alignment layer. The nanostructures or nanoantennas, moreover, may modulate the light, thus controlling both the LC orientation and the light modulation. The set of nanostructures or nanoantennas may sustain optical resonances at the operating frequency (or frequencies) of the LC device. These nanostructures or nanoantennas may be arranged in a lattice, forming a so called metasurface, and may be embedded in a thin layer of nematic liquid crystals. In some embodiments, the LC may be a dual frequency LC (DFLC). The electric field induced reorientation of LC molecules locally modifies the near-field environment of the nanoantenna, enabling highly efficient spectral tuning of their resonances and the associated amplitude and/or phase modulation. Compared to the conventional LC light modulators, the presence of nanoantennas or nanostructures may allow the thickness of the LC layer to be reduced significantly. The cross-talk between neighboring electrodes may also be reduced, thereby allowing pixel miniaturization. In contrast to conventional devices, various embodiments may utilize the design of geometry and periodic arrangement of the nanostructures or nanoantennas to help to remove the requirement of using an alignment layer to define the LC pre-alignment in the absence of applied bias, which helps to bring down the operational voltage range of the device and to increase its response speed.

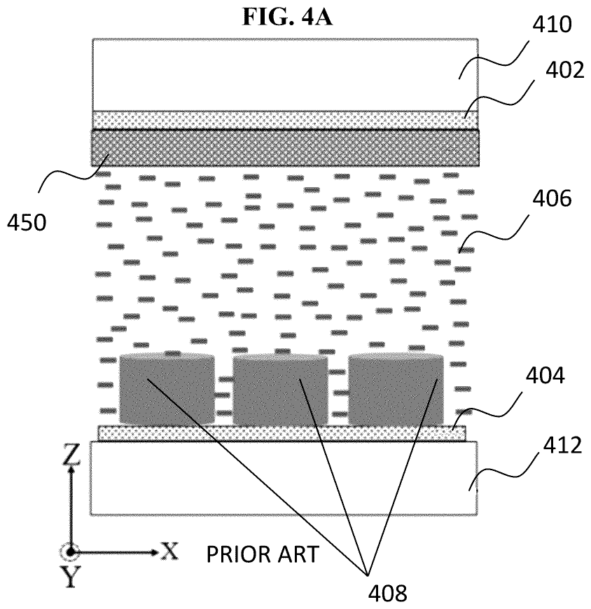

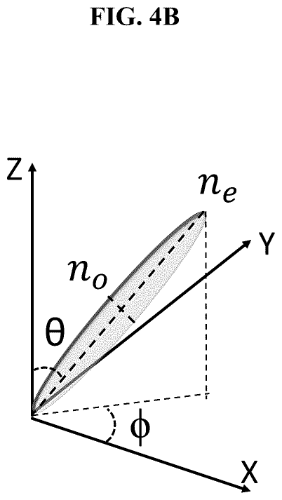

FIG. 4A shows a schematic of a cross-sectional side view of a unit cell of a conventional transmissive nanoantenna spatial light modulator (NSLM) with disc shaped nanoantennas 408. The nanoantennas 408 is included in a liquid crystal (LC) layer 406. The device is composed by the periodic repetition of these unit cells in both the X and Y directions. The device includes two substrates 410, 412 with transparent electrodes 402, 404, assembled to form the unit cell. Indium tin oxide (ITO) is used as the material for the transparent electrodes 402, 404. Instead of ITO, other transparent, electrically conductive materials such as aluminum doped zin oxide (AZO) could also be used. The bottom electrode 404 is pixelated, and the top electrode 402 is continuous. The top electrode is coated with an alignment layer 450, which is either a polymer or a monomer. The alignment layer 450 is treated to induce a preferential pre-alignment of the LC along the X-axis. There are two usual ways of controlling the direction of the alignment layer, which in turn controls the LC director (average orientation of LC molecules) alignment. The first method of treatment is carried out by irradiating a photosensitive material (e.g. azo-dye) with a polarized light source (light typically in ultraviolet (UV) range), and is known as photo-induced alignment. The second method is mechanical rubbing of polyimide or polystyrene. Alignment direction is defined by the polarization of UV in the first method and the direction of rubbing in the second method. Also, micro or nanostructured induced LC alignment has been reported, but at least a single side alignment layer or nanopatterning of the alignment layer 450 itself is used in most of the cases for achieving uniform LC alignment.

In contrast, various embodiments may not involve an alignment layer, and the metasurface itself may provide LC alignment in addition to wavefront modulation. Unless stated otherwise, comparisons between various embodiments and conventional methods of using alignment layers as described herein refer to comparisons between various embodiments and using alignment layers formed by the rubbing method, as the rubbing method is known to provide more reliability as compared to the photo-induced alignment method.

In various embodiments, the nanostructures or nanoantennas may be made of a high index dielectric material, e.g. titanium oxide (TiO₂), which may be formed on the bottom pixelated electrodes. The geometrical parameters of nanostructures or nanoantennas may be selected such that both electric dipoles (ED) and magnetic dipoles (MD) are excited and the nanostructures or nanoantennas are resonant at the visible wavelength range. The nanostructures or nanoantennas may cause a phase shift of 2π radians in transmission when the electric and magnetic resonances overlap each other or provide similar shifts using a single resonance in reflection. The metasurface periodicity (Pₓ and P_{y}) may be about 400 nm or any other suitable dimensions so that the unit cell would be sub-diffractive. The precise gap between the top and bottom electrodes may define the LC cell thickness, and may be a critical parameter. To achieve enough level of precision, a UV-curable adhesive (e.g. Norland optical adhesive NOA81) may be used to define the gap between the electrodes. Dual frequency liquid crystal (DFLC) molecules may be encapsulated in the cell through capillary filling, and thus the nanoantennas or nanostructures may be embedded in the liquid crystal layer.

FIG. 4B shows a schematic illustrating the orientation of a liquid crystal (LC) molecule used in the LC device according to various embodiments. The polar and azimuthal angles are depicted as θ and φ, respectively. In the nematic phase, the long axis of the molecules tends to align parallel to each other in a direction, the so-called director (\hat{n}), which is apolar. The LC refractive indices parallel and perpendicular to the director are called the extraordinary refractive index (nₑ) and the ordinary refractive index (nₒ), respectively. The difference (i.e., nₑ−nₒ) gives the birefringence (Δn). The birefringence of DFLC used in the current demonstration (DP002-016 from PhiChem-HCCH) is Δn=0.268 (nₑ=1.779, nₒ=1.511 at λ=589 nm, 20° C.). The DFLC may be a LC mixture which exhibits positive dielectric anisotropy (Δε>0) at lower frequencies, and negative dielectric anisotropy (Δε<0) at frequencies over the crossover frequency (≈60 kHz for DP002-016). This allows, for an applied voltage above the threshold, the reorientation of optic axis along the electric field at lower frequencies, and re-orientation of the optic axis perpendicular to the field direction at higher frequencies. The LC orientation may be specified by two parameters: the polar angle θ and the azimuthal angle φ as shown in FIG. 4B. For the conventional device shown in FIG. 4A, the polar angle θ can vary from 90° to 0° through electrical tuning, and the azimuthal angle φ is usually controlled by the alignment layer. According to various embodiments, the azimuthal angle φ may instead be defined by the geometry of the nanostructures or nanoantennas and the periodicity of the array. An incident electromagnetic with polarization along the X-axis may be labelled herein as P-0, and an incident electromagnetic with polarization along the Y-axis may be labelled herein as P-90.

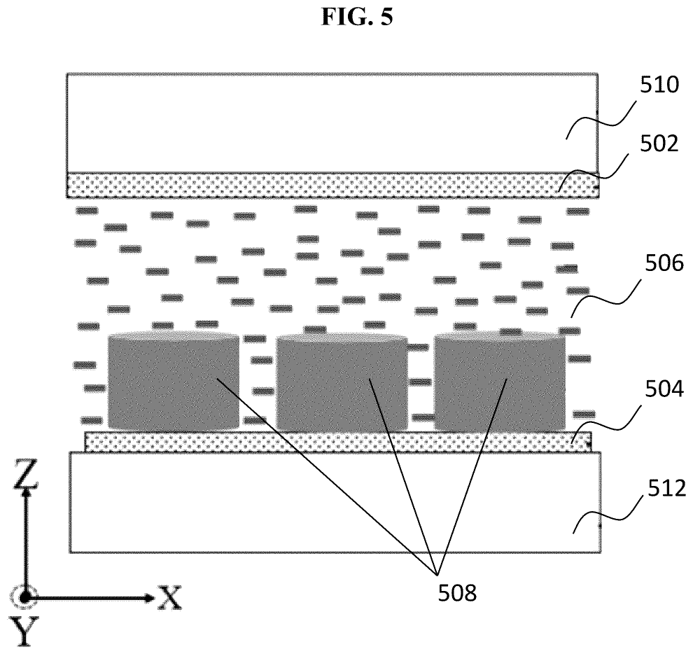

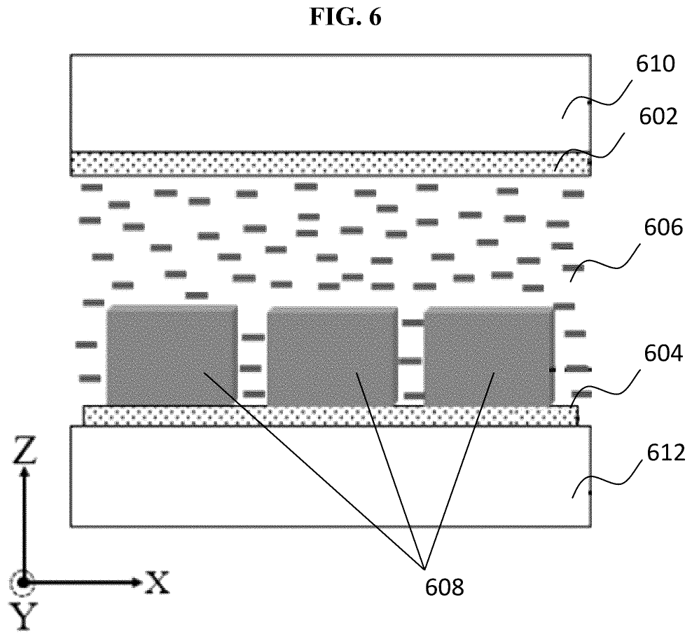

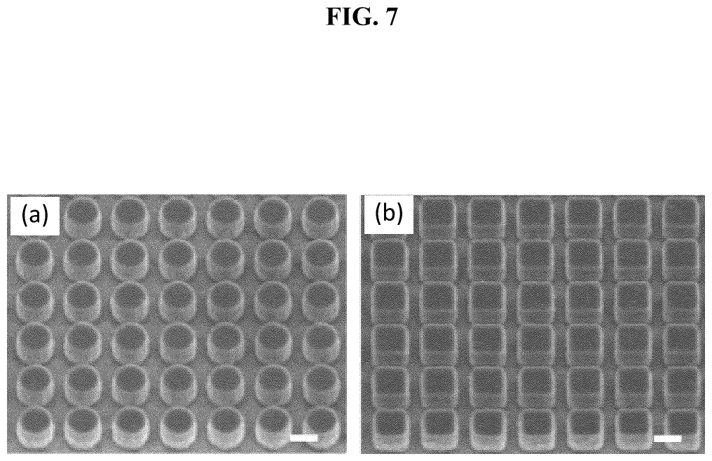

FIG. 5 shows a schematic of a cross-sectional side view of a unit cell of an ultra-thin liquid crystal (LC) device with disc shaped nanoantennas 508 and without a top electrode alignment layer. The nanoantennas 508 may be dielectric nanoantennas, and may be included in a liquid crystal layer 506 between a first electrode 502 (top transparent electrode) and a second electrode 504 (pixelated bottom transparent electrode). The first electrode 502 may be in contact with a first substrate 510, while the second electrode 504 may be in contact with a second substrate 512. The disc shaped nanoantennas 508 may each be in a shape of a disc across a horizontal cross-section. The diameter (D) and height (H) of each nanoantenna is 270 nm and 200 nm, respectively, i.e., D=270 nm, H=200 nm. The periodicity (P) of the array is 360 nm, i.e., P=360 nm. The full device is composed by the periodic repetition of the unit cell along the X and Y directions. FIG. 6 shows a schematic of a cross-sectional side view of a unit cell of another ultra-thin liquid crystal (LC) device with square shaped nanoantennas 608 and without a top electrode alignment layer. The nanoantennas 608 may be dielectric nanoantennas, and may be included in a liquid crystal layer 606 between a first electrode 602 (top transparent electrode) and a second electrode 604 (pixelated bottom transparent electrode). The first electrode 602 may be in contact with a first substrate 610, while the second electrode 604 may be in contact with a second substrate 612. The square shaped nanoantennas 608 may each be in a shape of a square across a horizontal cross-section. The length (L), width (W) and height (H) of each nanoantenna is 270 nm, 270 nm and 200 nm, respectively, i.e., L=270 nm, W=270 nm, H=200 nm. The periodicity (P) of the array is 360 nm, i.e., P=360 nm. In both designs, the LC alignment is completely defined by the nanoantenna, i.e., no alignment layer is present. FIG. 7 shows the scanning electron microscopy (SEM) images of (a) an array of disc shaped nanoantennas and (b) an array of square shaped nanoantennas.

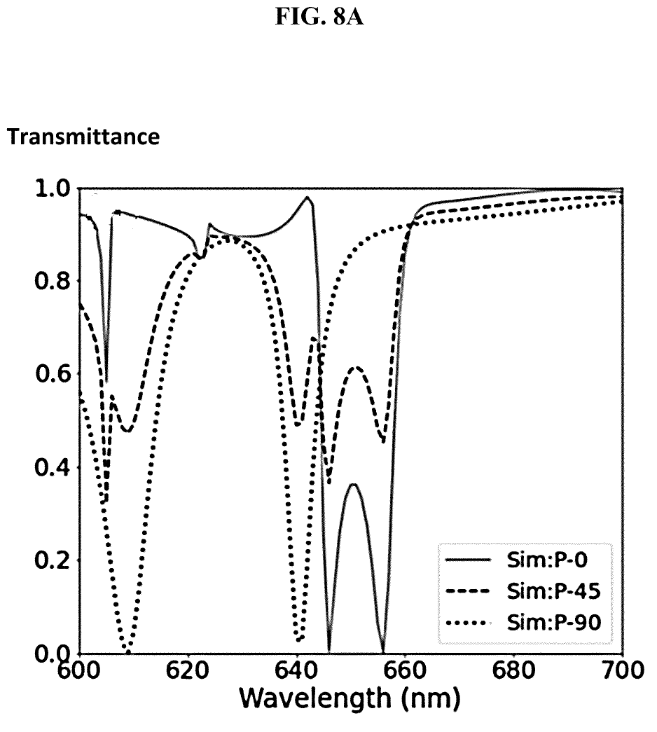

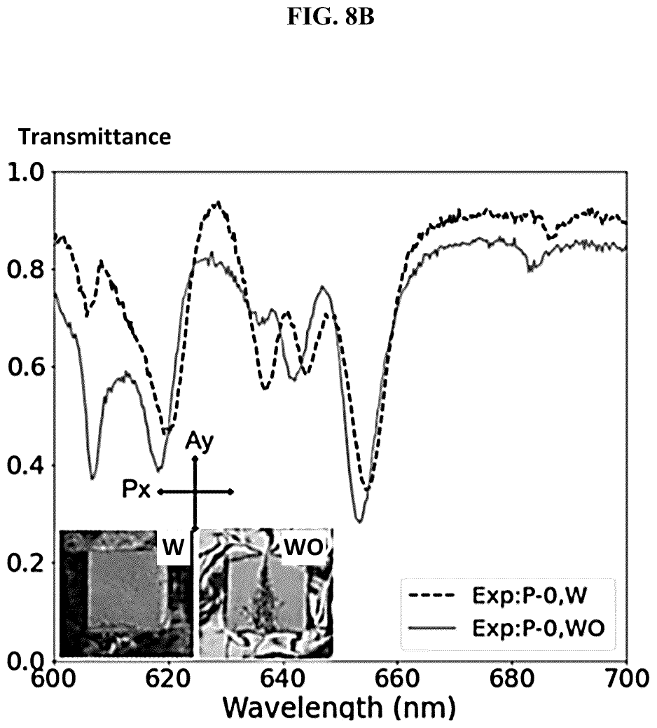

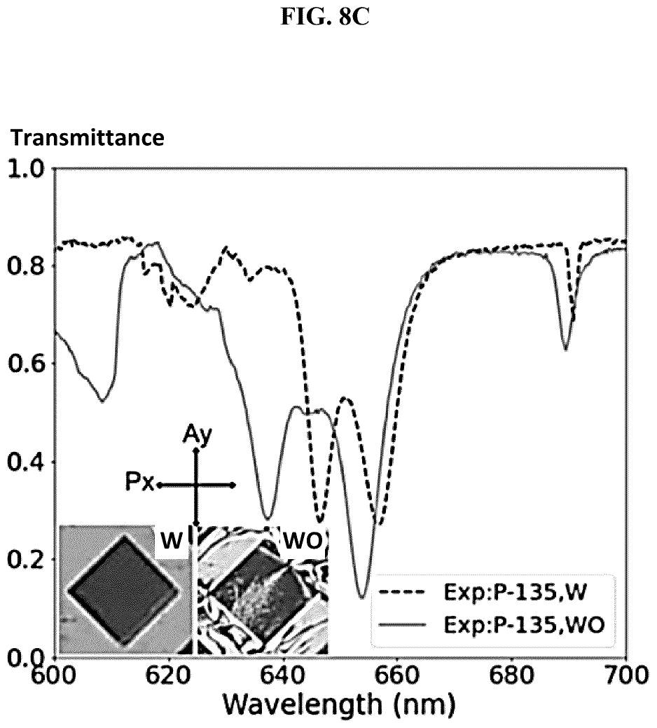

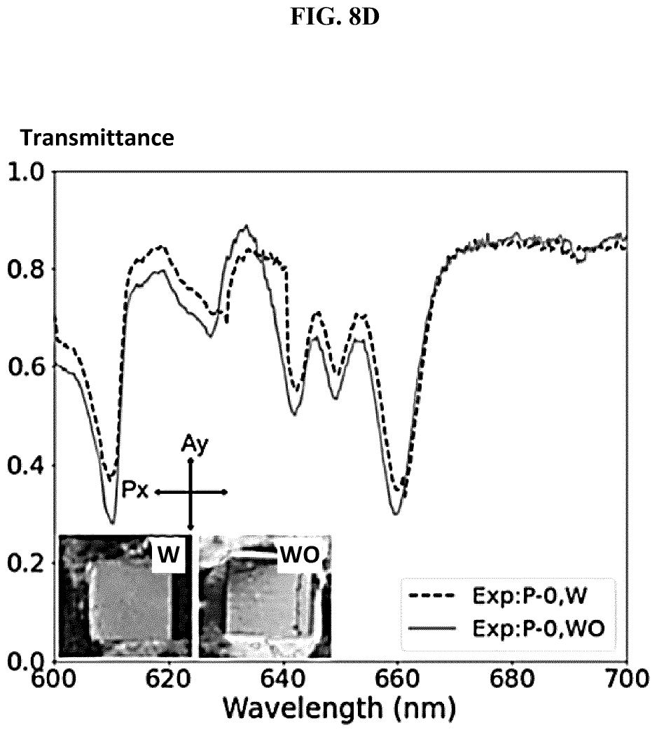

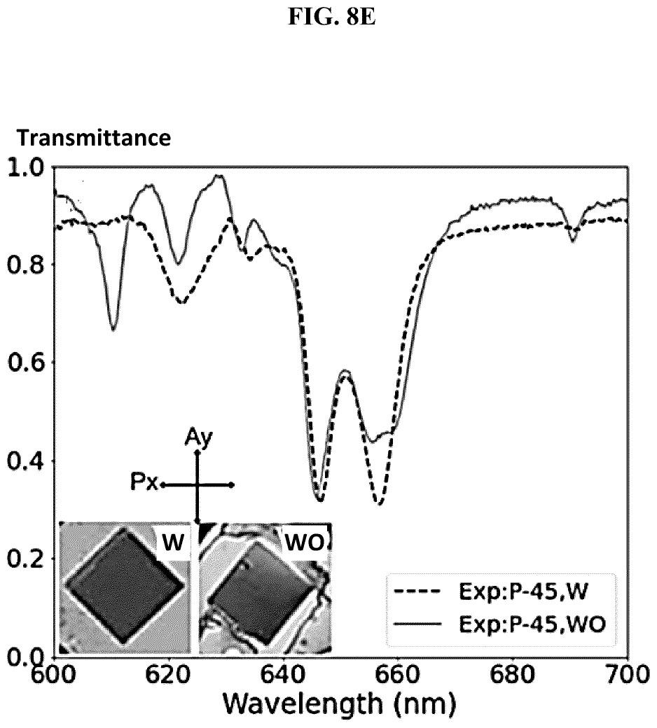

FIG. 8A shows a simulated plot of transmittance as a function of wavelength (in nanometers or nm) illustrating the transmission spectrum of the liquid device (LC) with the disc shaped nanoantennas as shown in FIG. 5 under illumination of normally incident light with polarizations along X-axis (P-0, solid line), along Y-axis (P-90, dotted line) and at an angle of 45° to the X-axis (P-45, dashed line). The simulation is done using COMSOL, and the refractive index nₑ is set along the X-axis (θ=90°, φ=0°). For P-O, electric and the magnetic resonances partially overlapped and the resonance dip at λ≈646 nm corresponds to the electric dipole and the resonance dip at λ≈657 nm to the magnetic dipole supported by the nano discs. The dip at ≈605 nm may be due to cavity modes formed in the slab. For P-90, the resonance splits λ≈610 nm corresponding to the electric dipole and λ≈640 nm corresponding to the magnetic dipole. For P-45, the multiple resonances appear since both parallel and perpendicular components of the electric dipole and the magnetic dipole are excited. FIG. 8B shows a measured plot of transmittance as a function of wavelength (in nanometers or nm) illustrating the transmission spectrum of the liquid crystal (LC) devices with 1500 nm thick liquid crystal (LC) layers as well as disc shaped nanoantennas arrays, and having an alignment layer (W, dashed line) or without an alignment layer (WO, solid line), under incident light with polarization along the X-axis, with the insets showing microscopic images of the cell without an alignment layer (WO) and with an alignment layer (W) under crossed polarizer (Pₓ) and analyzer (A_{y}). FIG. 8C shows a measured plot of transmittance as a function of wavelength (in nanometers or nm) illustrating the transmission spectrum of the liquid crystal (LC) devices with 1500 nm thick liquid crystal (LC) layers as well as disc shaped nanoantennas arrays, and having a top electrode alignment layer (W, dashed line) or without a top electrode alignment layer (WO, solid line), under incident light with polarization 135° to the X-axis, with the insets showing microscopic images of the cells without an alignment layer (WO) and with an alignment layer (W) under crossed polarizer (Pₓ) and analyzer (A_{y}). The rubbing direction and hence the LC orientation induced by the top electrode alignment layer is along the X-axis. Comparing the measured spectra with the simulation in FIG. 8A, the deviation in the resonance spectrum for the cell without alignment shows the disruption of homogeneous LC alignment for thicker cell in the absence of an alignment layer. Thick cells (>1 μm) need an alignment layer support for inducing homogeneous LC alignment throughout the cell thickness. The deviation from the uniform alignment and defect formation perturbs the resonance spectrum. The insets provide the images of the LC infiltrated metasurface under crossed polarizer (Pₓ) and analyzer (A_{y}) for the parallel and 45° orientation of metasurface arrays with respect to the X-axis. The black arrows indicate the directions of the polarizer and the analyzer during image recording. The images show the misalignment of LC molecules with the metasurface in the absence of an alignment layer. The resonance spectrum measured with incident light polarization 135° to X-axis (P- 135) matches with the simulation for P-0, and the resonance spectrum measured with incident light polarization P-O matches with the simulation for P-45. This shows that the metasurface may induce an angular alignment with respect to the X-axis, even in the presence of the alignment layer, which indicates the strong anchoring influence of the nanostructures. FIGS. 8D-E show the resonance spectra measured with similar metasurface-LC cells, but with thickness reduced to 750 nm.

FIG. 8D shows a measured plot of transmittance as a function of wavelength (in nanometers or nm) illustrating the transmission spectrum of the liquid crystal (LC) devices with 750 nm thick liquid crystal (LC) layers as well as disc shaped nanoantennas arrays, and having an alignment layer (W, dashed line) or without an alignment layer (WO, solid line), under incident light with polarization along the X-axis, with the insets showing microscopic images of the cell without an alignment layer (WO) and with an alignment layer (W) under crossed polarizer (Pₓ) and analyzer (A_{y}). FIG. 8E shows a measured plot of transmittance as a function of wavelength (in nanometers or nm) illustrating the transmission spectrum of the liquid crystal (LC) devices with 750 nm thick liquid crystal (LC) layers as well as disc shaped nanoantennas arrays, and having a top electrode alignment layer (W, dashed line) or without a top electrode alignment layer (WO, solid line), under incident light with polarization 45° to the X-axis, with the insets showing microscopic images of the cells without an alignment layer (WO) and with an alignment layer (W) under crossed polarizer (Pₓ) and analyzer (A_{y}). The resonance spectra measured from the cells with and without alignment for P-45 show good correspondence with each other and with the simulation in FIG. 8A for P-0. The periodic arrangement of nanoantenna can induce unform alignment of LC in the metasurface for the thin cell, but the induced alignment is angular. The induced alignment can be either 45° or 135° to the X-axis due to the symmetric structure of the nanoantenna. The images of LC infiltrated metasurface under crossed polarizer and analyzer given in the insets show the uniform alignment of LC in the metasurface array.

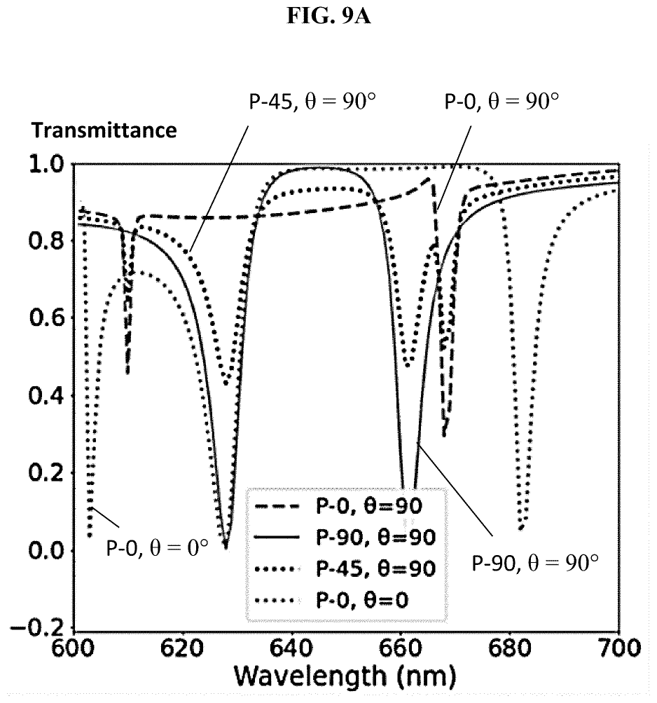

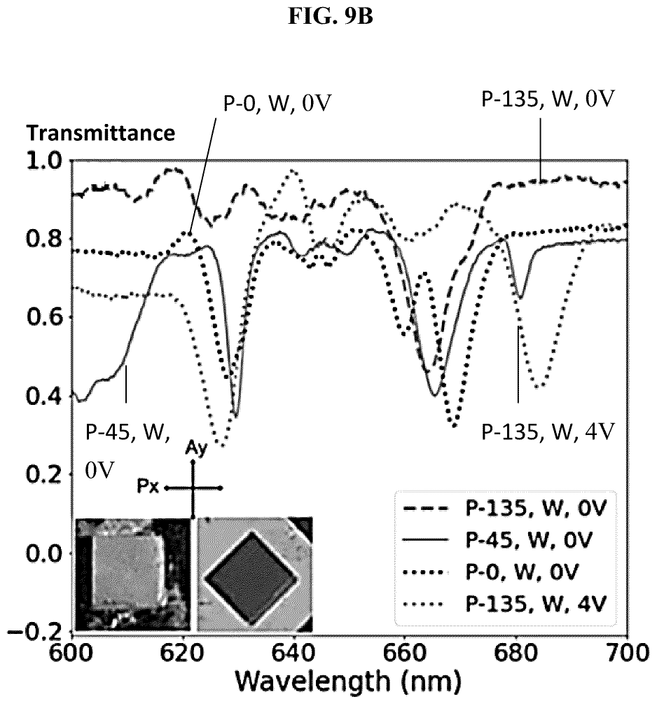

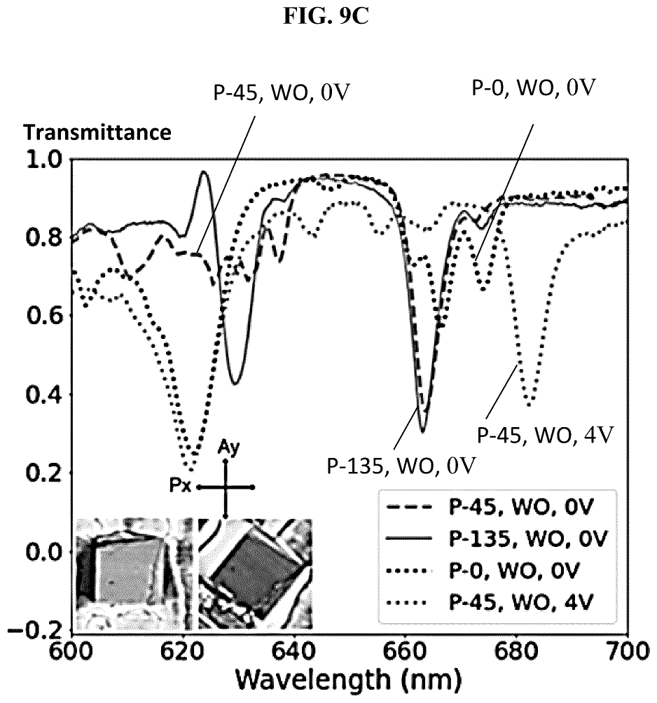

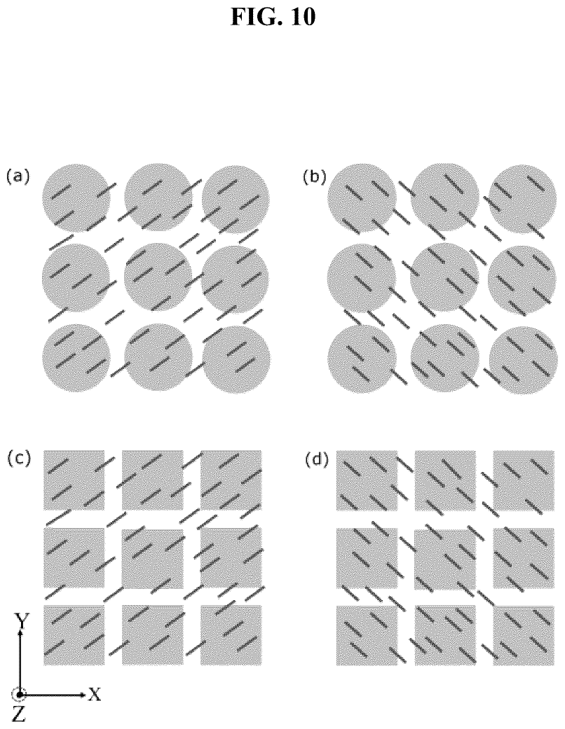

The metasurface induced LC alignment is verified using square shaped nanoantenna array. FIG. 9A shows a simulated plot of transmittance as a function of wavelength (in nanometers or nm) illustrating the transmission spectrum of the liquid device (LC) with the square shaped nanoantennas as shown in FIG. 6 under illumination of normally incident light with polarizations along X-axis, along Y-axis and at an angle of 45° to the X-axis. Assuming a homogeneous alignment of LC at zero applied field with θ=90°, for the incident polarization P-0, the dip observed at λ≈668 nm correspond to electric dipolar and magnetic dipolar resonances in the nanoantennas, with partial spectral overlap. For the homeotropic alignment of LC, the molecules are aligned vertically (θ=0°), which would correspond to the situation in which a bias, above the saturation value, is applied between the top and bottom electrodes. In this situation the resonances red shift to λ≈682 nm and higher order modes are excited at 628 nm. The dip at 603 nm is a cavity mode formed in the LC slab. Resonance shifting through homogeneous to homeotropic realignment is, thus, achievable by applying a field.

FIG. 9B shows a plot of transmittance as a function of wavelength (in nanometers or nm) shows a measured plot of transmittance as a function of wavelength (in nanometers or nm) illustrating the transmission spectrum of the liquid crystal (LC) devices with 750 nm thick liquid crystal (LC) layers as well as square nanoantennas arrays, and having an alignment layer (rubbing direction along the X-axis) for applied voltages of 0Vᵣₘₛ and 4Vᵣₘₛ under incident light with polarization P-135, and for applied voltage of 0Vᵣₘₛ, under incident light with polarization P-0 and incident light with polarization P-45, with the insets showing microscopic images of the cells with parallel orientation and 45° orientation under crossed polarizer (Pₓ) and analyzer (A_{y}). FIG. 9C shows a plot of transmittance as a function of wavelength (in nanometers or nm) shows a measured plot of transmittance as a function of wavelength (in nanometers or nm) illustrating the transmission spectrum of the liquid crystal (LC) devices with 750 nm thick liquid crystal (LC) layers as well as square nanoantennas, without an alignment layer for applied voltages of 0Vᵣₘₛ and 4Vᵣₘₛ under incident light with polarization P-45, and for applied voltage of 0Vᵣₘₛ, under incident light with polarization P-0 and incident light with polarization P-135, with the insets showing microscopic images of the cells with parallel orientation and 45° orientation under crossed polarizer (Pₓ) and analyzer (A_{y}). The black arrows indicate the direction of polarizer and analyzer during image recording. As highlighted above, FIG. 9B shows the measured transmission spectrum for the fabricated metasurface-LC device with an alignment layer present in the top electrode (with rubbing direction along the X-axis), while FIG. 9C shows the measured transmission spectrum for the metasurface-LC device with pure metasurface induced alignment for different applied voltages and incident polarization conditions. Comparing FIGS. 9B-C with FIG. 9A, for ultra-thin LC cell (thickness below 1 μm), the metasurface may be capable of inducing a uniform LC molecular alignment without requiring any alignment layer. However, for these nanostructures or nanoantennas with aspect ratios (AR) ~1:1, including disc shaped and square shaped nanostructures or nanoantennas, the metasurface may induce an angular alignment with azimuth angle φ of 45° or 135°, as seen by the transmission measurements.

FIG. 10 shows a schematic of a liquid crystal (LC) alignment induced by the nanostructures or nanoantennas having (a, b) shape of discs and (c, d) shape of squares. For the nanostructures or nanoantennas with AR~1:1 as those shown in FIG. 10, the nanostructures or nanoantennas may include an angular alignment with azimuth angle φ of 45° or 135°. In these nanostructures or nanoantennas, the anchoring energy is the same along the X direction and the U direction, and the free energy minimization gives φ≠0° LC alignment. The incident light polarization may need to be adjusted based on the initial light orientation angle of the LC, i.e., along the extraordinary refractive index to achieve maximum phase modulation for the devices described in FIGS. 5-6 . Moreover, for a device with AR~1:1 nanostructures or nanoantennas, even with ultra-thin cells and strong alignment from the top electrode alignment layer, it may not be possible to fully remove the angular alignment. Instead, a hybrid alignment of LC molecules may be induced.

As a summary, ultra-thin metasurface-LC cells can induce a homogeneous LC alignment, thus removing the need of standard LC alignment layers. However, with nanoantennas with AR~1:1 (and square lattices), only angular LC alignment may be possible. This might be an issue or unwanted for certain applications. The above issue may be overcome by using other antenna designs, capable of inducing LC alignment along a desired or designated direction, including φ=0° or φ=90°, while keeping the desired optical resonances necessary for light modulation.

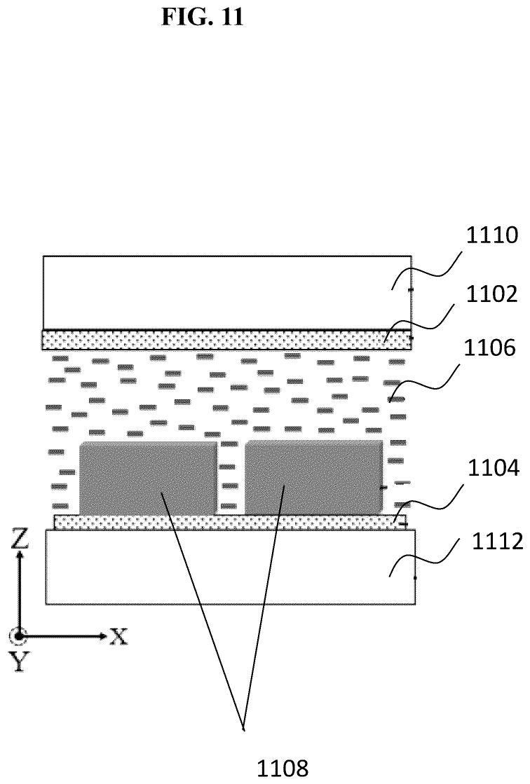

Various embodiments may induce parallel alignment of the liquid crystal (LC) molecules along a desired or designated direction. In various embodiments, each nanostructure or nanoantenna may have a larger aspect ratio in the direction in which alignment is desired. In other words, the dimension of the nanostructure or nanoantenna along the direction in which LC alignment is desired should be larger than dimensions along any other direction. The aspect ratio may be 2:1, 3:1 etc. The nanostructure or nanoantenna may be a rectangular block, a cylinder with elliptical cross-section or an ellipsoidal shaped nanoparticle, amongst others. Various embodiments may induce alignment of the LC molecules along a desired or designated direction other than angular alignment with azimuth angle φ of 45° and/or 135°. FIG. 11 shows a schematic of a cross-sectional side view of a unit cell of an ultra-thin liquid crystal (LC) device according to various embodiments. The nanoantennas 1108 may be dielectric nanoantennas, and may be included in a liquid crystal layer 1106 between a first electrode 1102 (top transparent electrode) and a second electrode 1104 (pixelated bottom transparent electrode). The first electrode 1102 may be in contact with a first substrate 1110, while the second electrode 1104 may be in contact with a second substrate 1112. The nanoantennas 1108 may be of rectangle blocks, i.e., rectangular cuboids. Each nanoantenna 108 may be rectangle shaped across a horizontal cross-section, and may be referred as rectangular nanostructures or nanoantennas.

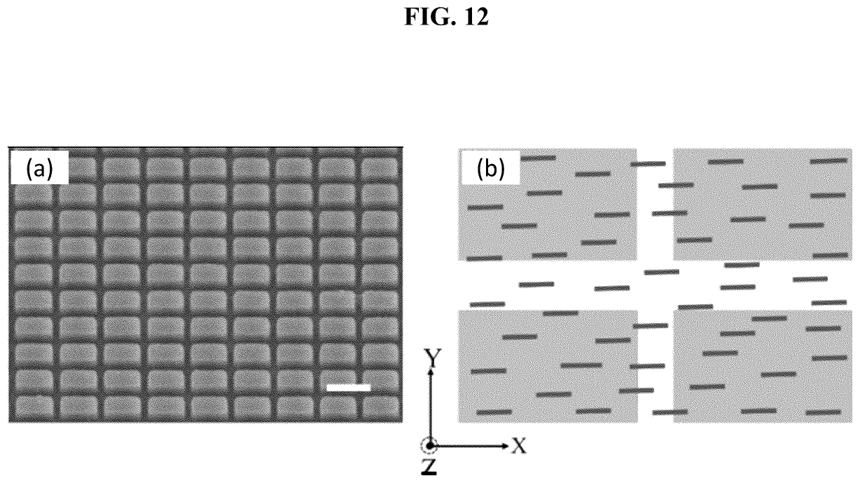

An additional or alternative means to induce LC alignment along a certain direction is by using periodic lattice with a longer lattice vector along the desired alignment direction. This can be achieved, e.g. using a rectangular lattice instead of a square one. In the device shown in FIG. 11, a periodicity of the array along the X-axis may be greater than a periodicity along the Y-axis. FIG. 12 shows (a) a scanning electron microscopy (SEM) image of fabricated rectangular nanoantenna metasurface according to various embodiments; and (b) a schematic illustrating the alignment of the liquid crystal molecules induced by the rectangular nanostructures or nanoantennas according to various embodiments. The length (L), width (W) and height (H) of each nanoantenna in FIG. 12(a) is 370 nm, 200 nm and 200 nm, respectively, i.e., L=370 nm, W=200 nm, H=200 nm. The periodicity (Pₓ) of the array along the X-axis is 430 nm while the periodicity of the array along the Y-axis (P_{y}) is 280 nm, i.e., Pₓ=430 nm, P_{y}=280 nm. The scale bar in FIG. 12(a) is 450 nm.

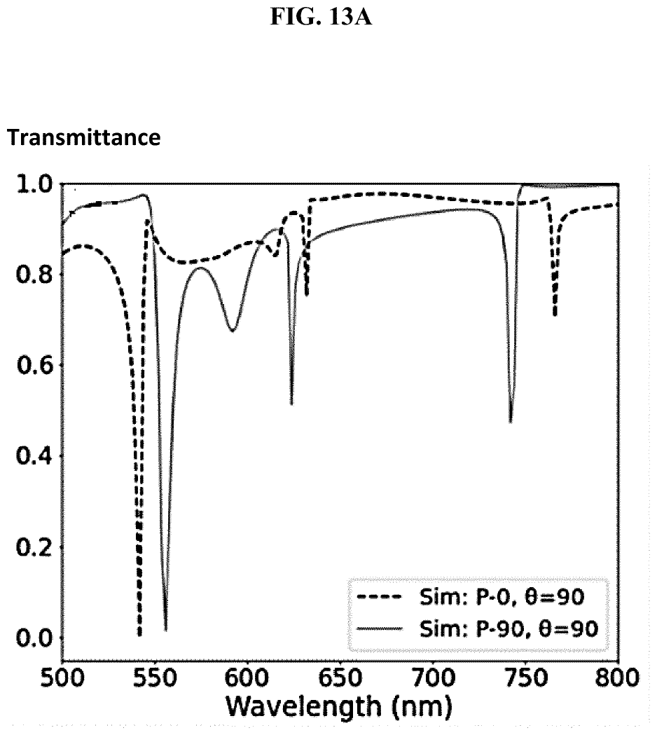

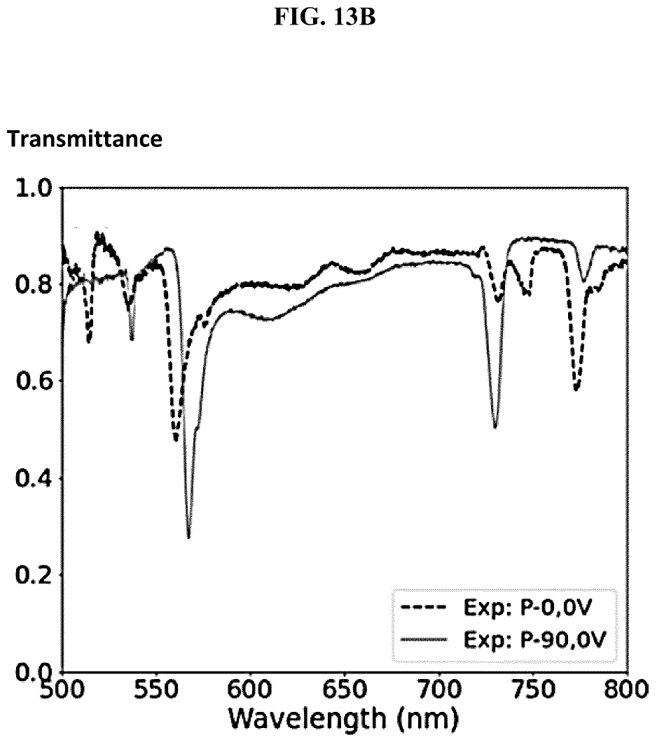

FIG. 13A shows a simulated plot of transmittance as a function of wavelength (in nanometers or nm) illustrating the transmission spectrum of the liquid device (LC) with the rectangular nanoantennas according to various embodiments as shown in FIG. 11 under illumination of normally incident light with polarizations along X-axis (P-0, dashed line) and along Y-axis (P-90, solid line). The LC molecules may be induced to be aligned along the X-direction, i.e., along the length or long axis of the rectangular nanoantennas (L=370 nm, W=200 nm, H=200 nm, Pₓ=430 nm, P_{y}=280 nm) . For the incident wave with polarization along X-axis (P-0), the magnetic and electric dipoles may coexist at λ=768 nm, while the nanoantennas have higher order modes of electric and magnetic resonance at λ=544 nm. These resonances can be tuned by applying electric field to the LC device, as shown below. When the polarization is along the Y-axis (P-90), it can be seen that the main mode at longer wavelength blue-shifts. FIG. 13B shows a measured plot of transmittance as a function of wavelength (in nanometers or nm) illustrating the transmission spectrum of the liquid device (LC) with the rectangular nanoantennas according to various embodiments as shown in FIG. 11 under illumination of normally incident light with polarizations along X-axis (P-0, dashed line) and along Y-axis (P-90, solid line). Comparing the simulated results as shown in FIG. 13A with the measured results as shown in FIG. 13B, it can be seen that the device as shown in FIG. 11 may be able to provide homogeneous LC alignment along the desired direction, i.e., with the azimuthal angle o near zero. The LC alignment may be determined by the AR of the nanoantennas (i.e., the longest dimension of the nanoantenna) and/or the periodic lattice.

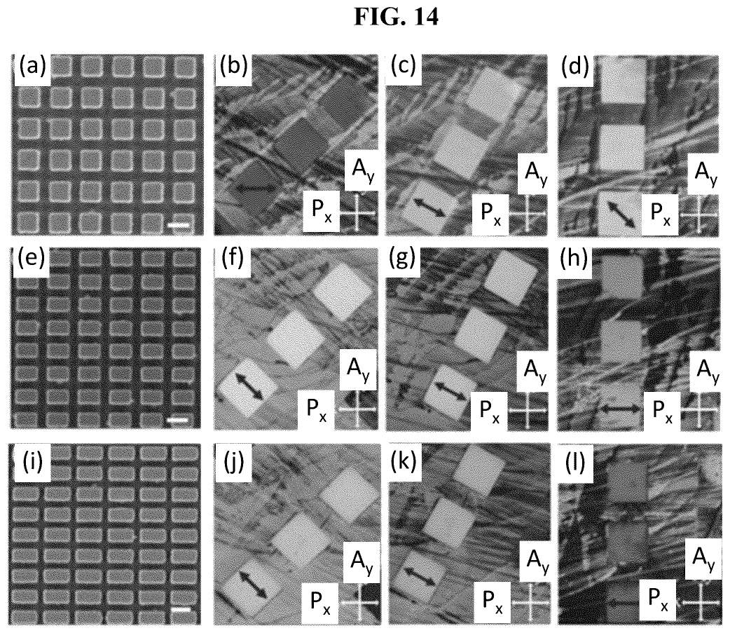

FIG. 14 shows (a) scanning electron microscopy (SEM) images of fabricated nano-square nanoantennas (L=W=270 nm, H=200 nm, Pₓ=P_{y}=360 nm) ; (b)-(d) microscopy images of the fabricated square nanoantennas shown in (a) under crossed polarizer (Pₓ) and analyzer (A_{y}) for different array orientations; (e) scanning electron microscopy (SEM) images of fabricated rectangular nanoantennas according to various embodiments (L=260 nm, W=180 nm, H=200 nm, Pₓ=360 nm, P_{y}=290 nm) ; (f)-(h) microscopy images of the fabricated rectangular nanoantennas shown in (e) according to various embodiments under crossed polarizer (Pₓ) and analyzer (A_{y}) for different array orientations; (i) scanning electron microscopy (SEM) images of fabricated rectangular nanoantennas according to various embodiments (L=350 nm, W=180 nm, H=200 nm, Pₓ=430 nm, P_{y}=270 nm); (j)-(1) microscopy images of the fabricated rectangular nanoantennas shown in (i) according to various embodiments under crossed polarizer (Pₓ) and analyzer (A_{y}) for different array orientations. FIG. 14 illustrates the dependence of the LC alignment based on the nanoantenna aspect ratio for LC devices without an alignment layer. All the nanoantennas are fabricated on a single substrate with the nanoantennas including TiO₂. The LC device has a thickness of 500 nm without an alignment layer. The images show that the nanoantennas with an AR of 1:1 may induce angular alignment, and rectangular nanoantennas with AR>1:1 may allow controlled LC alignment in the desired direction. Various embodiments may provide means of precisely controlling the LC alignment without need for any additional alignment layer, while still preserving the desired optical response of the LC device. The scale bar in FIG. 14(a), (e), (i) represents 270 nm.

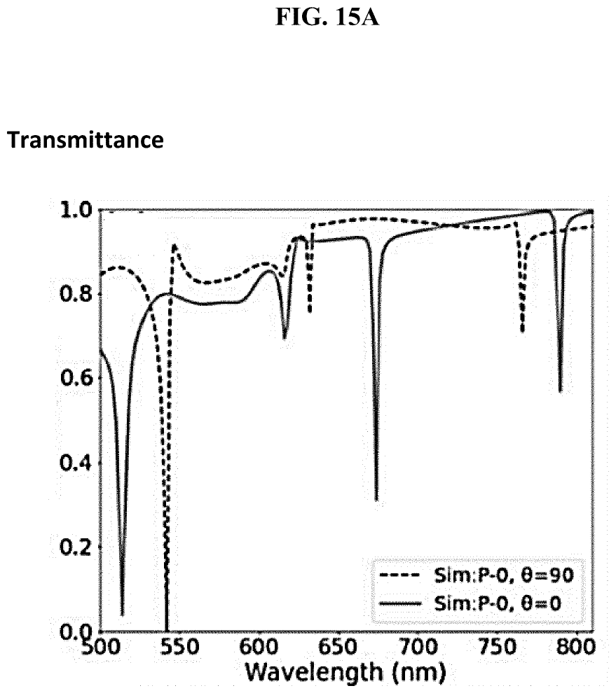

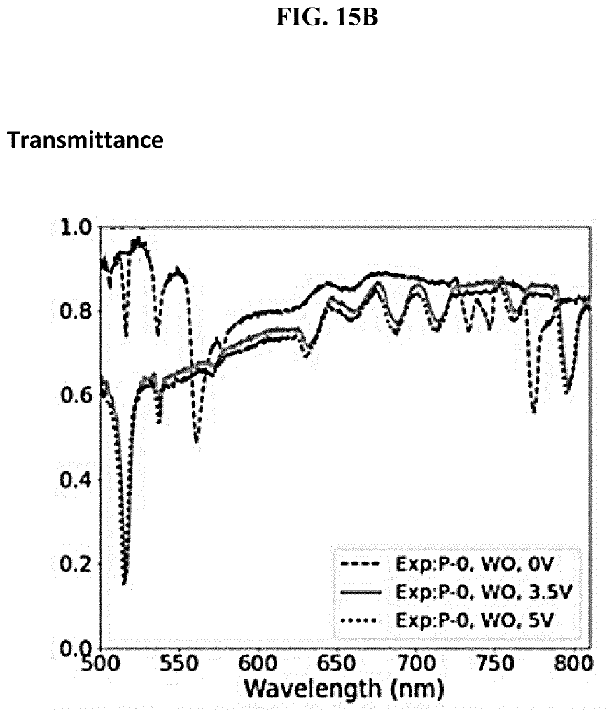

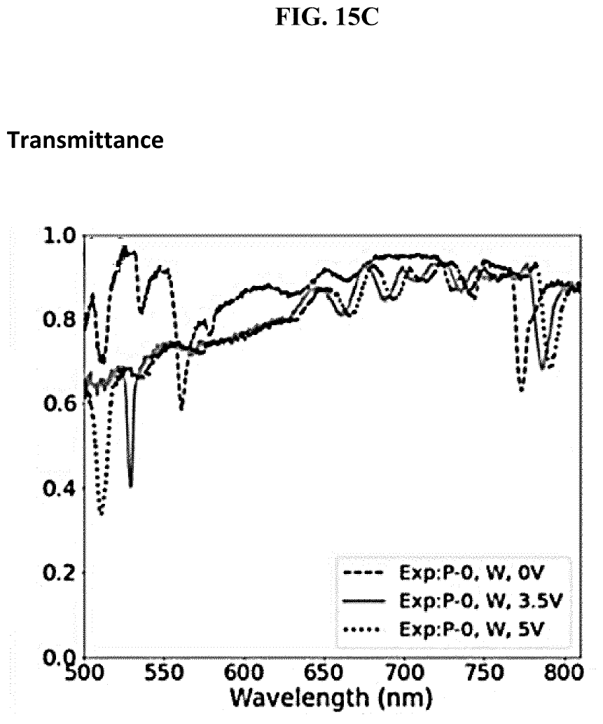

Various embodiments may improve device performance parameters, namely the response speed and driving voltage. Since an additional alignment layer, which is known to strongly affect the behavior of neighboring LC molecules, is not required, the voltage level required for light modulation may be reduced (e.g. to half) and the response speed may be increased (e.g. 3 times faster compared to a device with an alignment layer). The reduced response time may help to increase the refresh rate of the device. The electrical tuning of rectangular nanoantenna resonance is shown in FIGS. 15A-C. FIG. 15A shows a simulated plot of transmittance as a function of wavelength (in nanometers or nm) illustrating the transmission spectrum of the liquid device (LC) with the rectangular nanoantennas for homogeneous (θ=90°, solid line) liquid crystal (LC) alignment and for homeotropic (θ=0°, dashed line) liquid crystal (LC) alignment under incident light with polarization along the X-axis (P-0) according to various embodiments. FIG. 15B shows a measured plot of transmittance as a function of wavelength (in nanometers or nm) illustrating the transmission spectrum of the liquid device (LC) with the rectangular nanoantennas and without an alignment layer for applied voltages 0Vᵣₘₛ, 3.5Vᵣₘₛ and 5Vᵣₘₛ under incident light with polarization along the X-axis (P-0) according to various embodiments. FIG. 15C shows a measured plot of transmittance as a function of wavelength (in nanometers or nm) illustrating the transmission spectrum of the liquid device (LC) with the rectangular nanoantennas and with an alignment layer for applied voltages 0Vᵣₘₛ, 3.5Vᵣₘₛ and 5Vᵣₘₛ under incident light with polarization along the X-axis (P-0). Comparing the measurement results of the cell with pure metasurface induced alignment (FIG. 15B) and the cell with top electrode alignment layer (FIG. 15C) in terms of resonance displacement with respect to applied voltage, the cell with pure metasurface induced alignment may require a lower voltage than the cell with top electrode alignment layer for wavefront modulation.

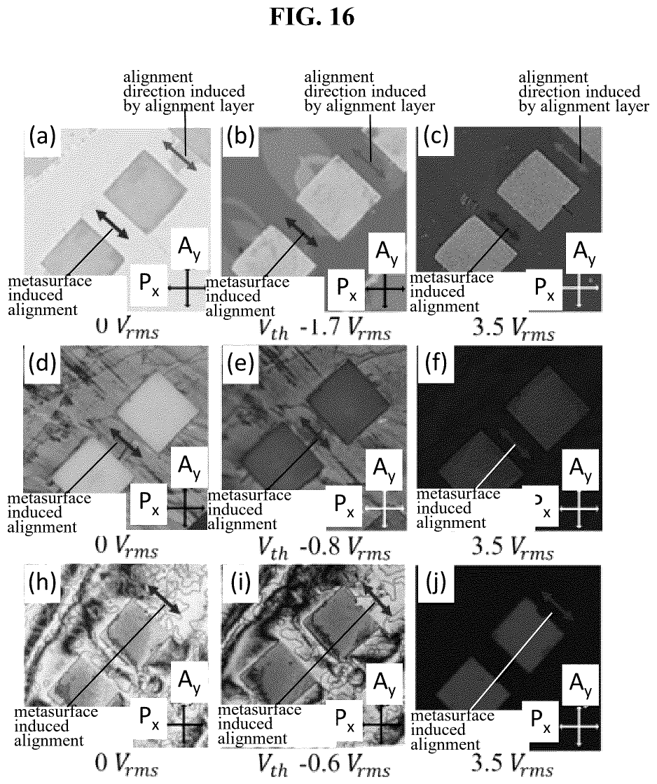

FIG. 16 shows microscopy images of liquid crystal (LC) infiltrated rectangular nanoantennas under crossed polarizer (Pₓ) and Analyzer (A_{y}) for (a)-(c) 500 nm thick liquid crystal (LC) cell with top electrode alignment layer under different applied voltages; (d)-(f) 500 nm thick liquid crystal (LC) cell with pure metasurface induced alignment without top electrode alignment layer according to various embodiments under different applied voltages; and (h)-(j) 1000 nm thick liquid crystal (LC) cell with pure metasurface induced alignment without top electrode alignment layer according to various embodiments under different applied voltages. One set of arrows indicates the LC director which is orientated along the length or long axis of the rectangular nanoantennas, while another set of arrows indicates the alignment direction induced by the top electrode alignment layer. The polarizer and analyzer directions are also shown in FIG. 16. As shown in FIG. 16, the threshold voltage required for the LC switching in the cell with pure metasurface induced alignment may be in the 0.6 Vᵣₘₛ to 0.8 Vᵣₘₛ range, while that of the cell with the alignment layer may need a minimum of 1.4 Vᵣₘₛ.

Another driving parameter, the response time, may also depend on the anchoring strength and the cell thickness. The total response time may be defined as the sum of rise time and decay time.

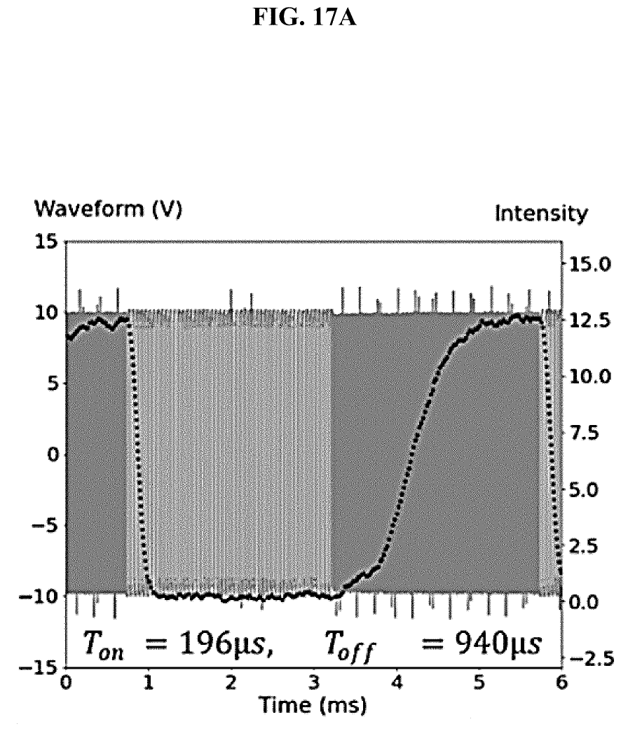

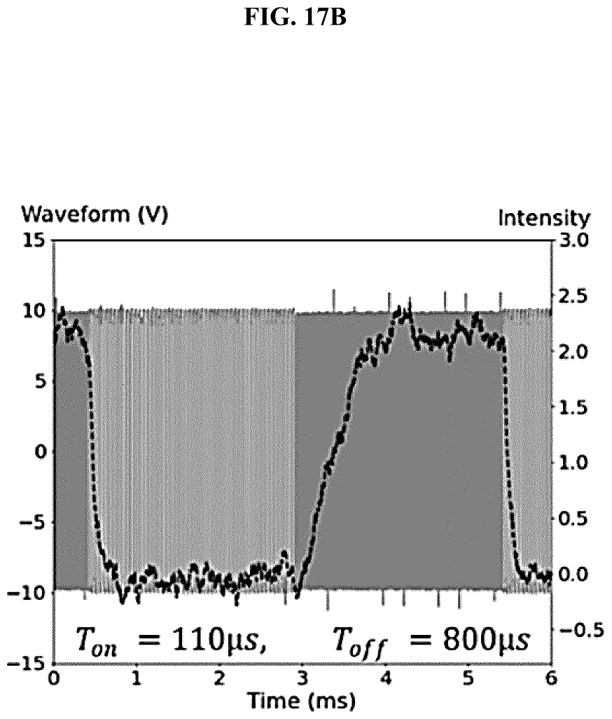

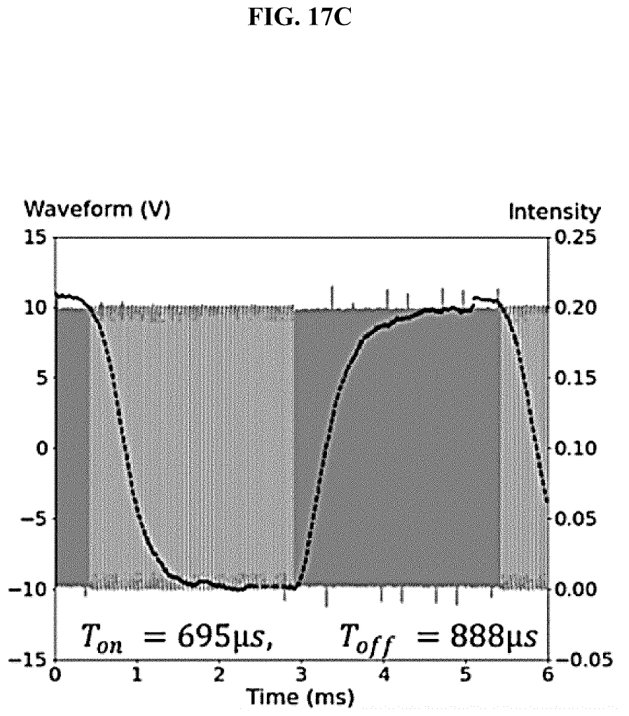

FIGS. 17A-C show the response time measurements of miniaturized meta-surfce-LC cells with rectangular nanoantennas according to various embodiments. FIG. 17A shows a plot of waveform (in volts or V)/ intensity as a function of time (in milliseconds or ms) illustrating the switch performance (voltage dependent transmitted intensity-black dotted line) of a 1000 nm thick cell without alignment layer according to various embodiments under applied signals (grey lines). FIG. 17B shows a plot of waveform (in volts or V)/ intensity as a function of time (in milliseconds or ms) illustrating the switch performance (voltage dependent transmitted intensity-black dotted line) of a 750 nm thick cell without alignment layer according to various embodiments under applied signals (grey lines). FIG. 17C shows a plot of waveform (in volts or V)/ intensity as a function of time (in milliseconds or ms) illustrating the switch performance (voltage dependent transmitted intensity-black dotted line) of a 750 nm thick cell with a top electrode alignment layer under applied signals (grey lines). In these measurements, the dual frequency driving method is used, where both ‘on’ and ‘off’ are voltage driven. The dual-frequency pulse is switched between ƒ_{low}=20 kHz and ƒ_{high} =200 kHz for applied voltage 10Vₚₚ.

As can be seen, for the cell with pure metasurface induced alignment, the total response time is reduced to less than 1 ms. While the ‘off’ time is almost same for both types of cells, and varies depending on the cell thickness, the ‘on’ time in the metasurface induced alignment is reduced by more than 3× compared to the case when the alignment layer is present, as shown in FIG. 17C, due to the increased anchoring energy from the alignment layer. In FIGS. 17A-C, the ‘on’ and ‘off’ times may not be equal even if both are voltage driven. This may be due to the difference in the dielectric anisotropy at 20 kHz (Δε=4.7) and 200 kHz (Δε=−2.7). The ‘on’ and ‘off’ times can be equalized to few hundreds of microseconds by optimizing the voltage and frequency combination of the applied signal.

Various embodiments may be modified to achieve better performance or different functionalities. In this regard, the inclusion of additional elements or characteristics of the elements may be helpful. For instance, various embodiments may include a conductive mirror (e.g. a dielectric mirror in combination with a transparent electrical conductor) instead of a transmissive bottom electrode to help to accumulate more phase since light is passing through the device more than once. In various other embodiments, the transmissive bottom electrode may be replaced by a metal electrode, which may act as a mirror.

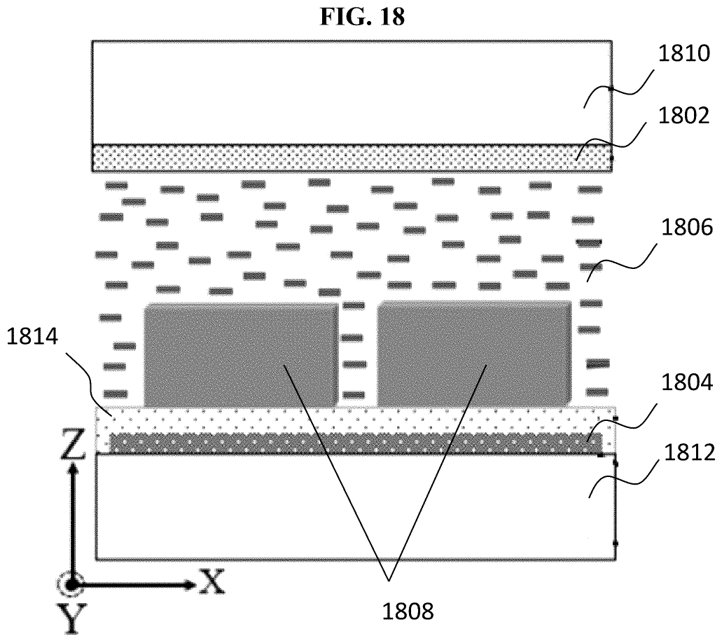

FIG. 18 shows a schematic of a cross-sectional side view of a unit cell of a liquid crystal (LC) device with rectangular nanoantennas 1808 according to various embodiments. The nanoantennas 1808 may be dielectric nanoantennas, and may be included in a liquid crystal layer 1806 between a first electrode 1802 (top transparent electrode) and a second electrode 1804 (pixelated bottom reflective electrode). The first electrode 1802 may be in contact with a first substrate 1810. The first electrode 1802 may be made of indium tin oxide (ITO), while the second electrode 1804 may be made of aluminum (Al) or any other suitable metals such as gold (Au), silver (Ag), copper (Cu) etc.. Alternatively, the second electrode 1804 may be a dielectric mirror (e.g. a Bragg reflector) in combination with a transparent electrical conductive material. The first electrode 1802 may be transparent and electrically conductive. The second electrode 1804 may act as both an electrode and a mirror. The second electrode 1804 may be highly reflective and at the same time be electrically conductive and pixelated. The LC device may also include a passivation layer 1814 formed on or in contact with the second electrode 1804 such that direct contact between LC molecules with the second electrode 1804 is avoided. The passivation layer 1814 may include a low index (n<2) and transparent material (e.g. an oxide material) to avoid optical losses in the metal of the second electrode 1804.

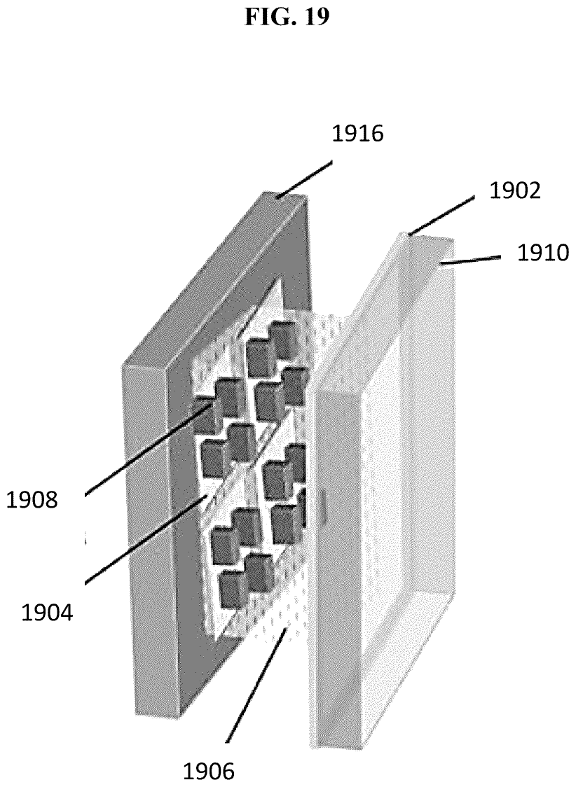

Embodiments with a pixelated bottom electrode may include pixels which are addressed individually by an integrated circuit in the complementary metal oxide semiconductor (CMOS) backplane. FIG. 19 shows a schematic of a perspective view of a unit cell of a liquid crystal (LC) device with rectangular nanoantennas 1908 and a pixelated second electrode 1904 according to various embodiments. The nanoantennas 1908 may be dielectric nanoantennas, and may be included in a liquid crystal layer 1906 between a first electrode 1902 and the second electrode 1904. The first electrode 1902 may be a transparent electrode, while the second electrode 1904 may include two dimensional (2D) pixels. The second electrode 1904 may be in electrical contact with a CMOS backplane 1916.

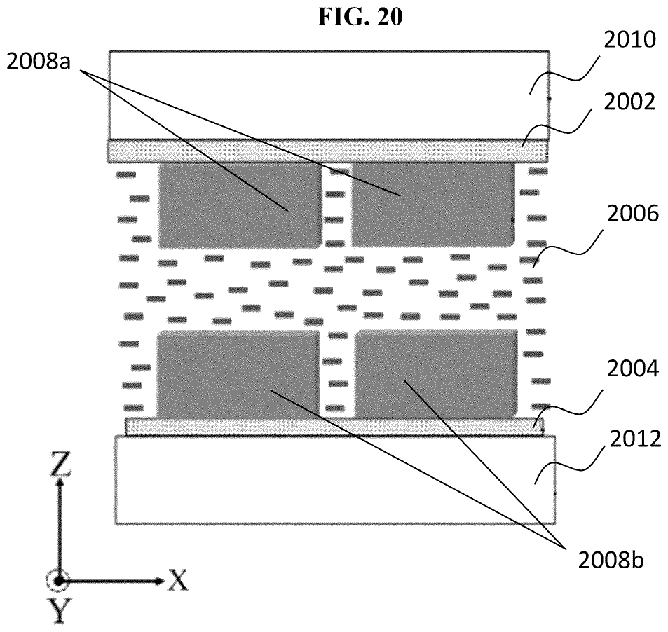

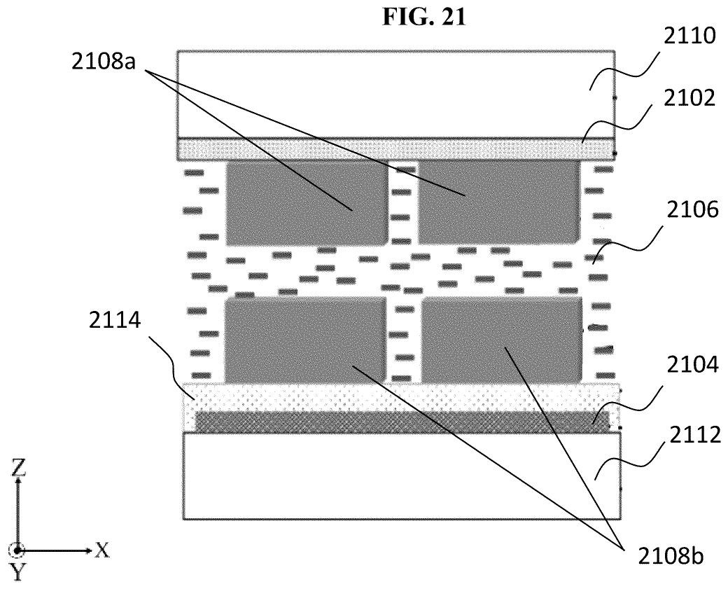

FIG. 20 shows a schematic of a cross-sectional side view of a unit cell of a transmissive liquid crystal (LC) device with rectangular nanoantennas 2008a, 2008b on or in contact with the first electrode 2002 and the second electrode 2004 respectively according to various embodiments. The rectangular nanoantennas 2008a, 2008b may be included in a liquid crystal layer 2006 between the first electrode 2002 (top transparent electrode) and the second electrode 2004 (pixelated bottom transparent electrode). The rectangular nanoantennas 2008a, 2008b may be at opposing sides of the liquid crystal layer 2006. The rectangular nanoantennas 2008a may be in contact with the first electrode 2002, while the rectangular nanoantennas 2008b may be in contact with the second electrode 2004. The first electrode 2002 may be in contact with a first substrate 2010, while the second electrode 2004 may be in contact with a second substrate 2012. FIG. 21 shows a schematic of a cross-sectional side view of a unit cell of a reflective liquid crystal (LC) device with rectangular nanoantennas 2108a, 2108b on opposing sides on a liquid crystal layer 2106 according to various embodiments. The nanoantennas 2108a, 2108b may be dielectric nanoantennas, and may be included in the liquid crystal layer 2106 between a first electrode 2102 (top transparent electrode) and a second electrode 2104 (pixelated bottom metal electrode). The first electrode 2102 may be in contact with a first substrate 2110, and the second electrode 2104 may be in contact with a second substrate 2112. The LC device may also include a passivation layer 2114 formed on or in contact with the second electrode 2104 such that direct contact between LC molecules with the second electrode 2104 is avoided. The rectangular nanoantennas 2108b may be in contact with the passivation layer 2114.

FIGS. 20-21 show devices with two arrays of nanoantennas or nanostructures. The two arrays of nanoantennas or nanostructures may be at opposing sides on the liquid crystal layer. Having nanoantennas or nanostructures may provide well defined LC alignment, even for thicker LC cells, and may also help to achieve larger light modulation simultaneously. For instance, the independent phase accumulation from the top nanoantenna array and the bottom nanoantenna array may add up at specific wavelength to provide larger phase modulations. Changing the nanoantenna structure or orientation may also be helpful in achieving other functionalities or other uniform LC alignment.

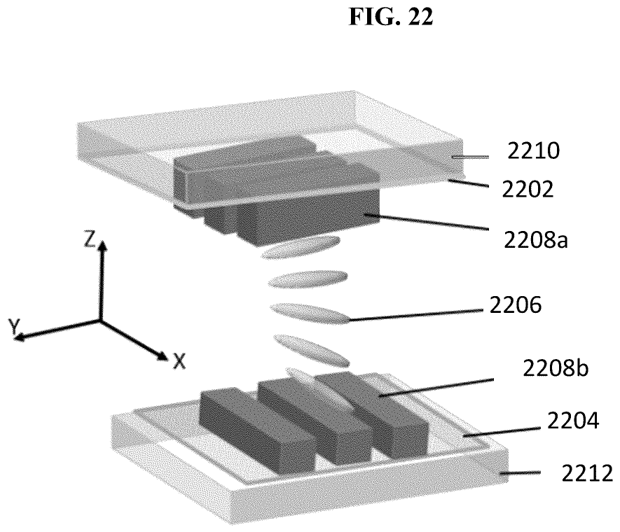

FIG. 22 shows a schematic of a cross-sectional side view of a unit cell of a liquid crystal (LC) device with two arrays of rectangular nanoantennas 2208a, 2208b aligned perpendicular to each other according to various embodiments. The lengths of the rectangular nanoantennas 2208a may be perpendicular to the lengths of the rectangular nanoantennas 2208b. The array of nanoantennas 2208a may be aligned along the Y-axis direction, while the array of nanoantennas 2208b may be aligned along the X-axis direction. The two arrays of rectangular nanoantennas 2208a, 2208b may be included in opposing sides of a liquid crystal layer containing LC molecules 2206. The orientation of the two arrays of rectangular nanoantennas 2208a, 2208b may achieve twisted nematic alignment of the LC molecules (along the Z-axis). The LC layer may be between the first electrode 2202 (top transparent electrode) and the second electrode 2204 (pixelated bottom transparent electrode). The first electrode 2202 may be in contact with a first substrate 2210, while the second electrode 2204 may be in contact with a second substrate 2212. The resonant character of the nanoantennas may simultaneously strengthen the polarization conversion or chirality of light.

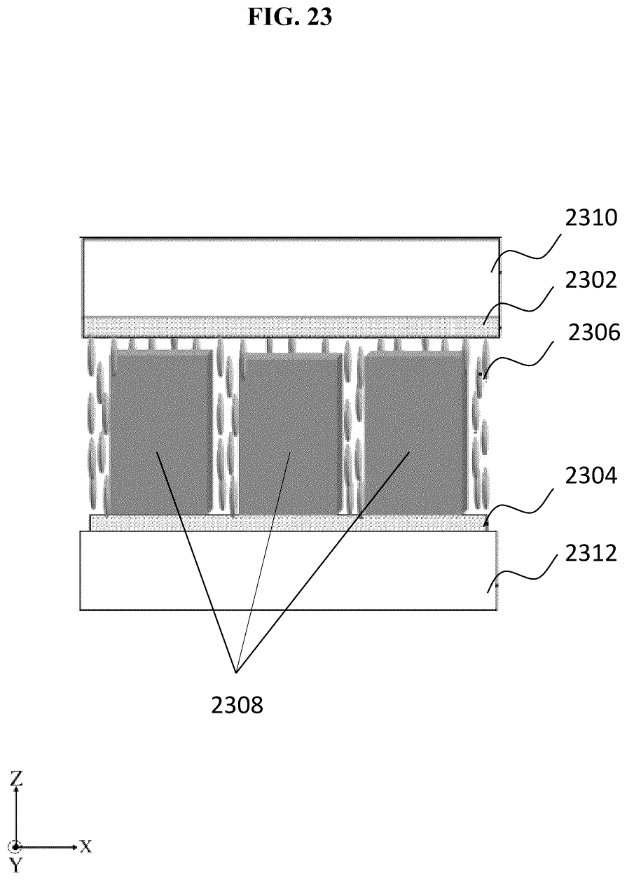

FIG. 23 shows a schematic of a cross-sectional side view of a unit cell of a transmissive liquid crystal (LC) device with an array of nanopillars 2308 according to various embodiments. The height of the nanopillars 2308 may be greater than the other dimensions of the nanopillars. The nanopillars 2308 may be dielectric nanoantennas, and may be included in a liquid crystal layer 2306 between a first electrode 2302 (top transparent electrode) and a second electrode 2304 (pixelated bottom transparent electrode). The first electrode 2302 may be in contact with a first substrate 2310, while the second electrode 2304 may be in contact with a second substrate 2312.

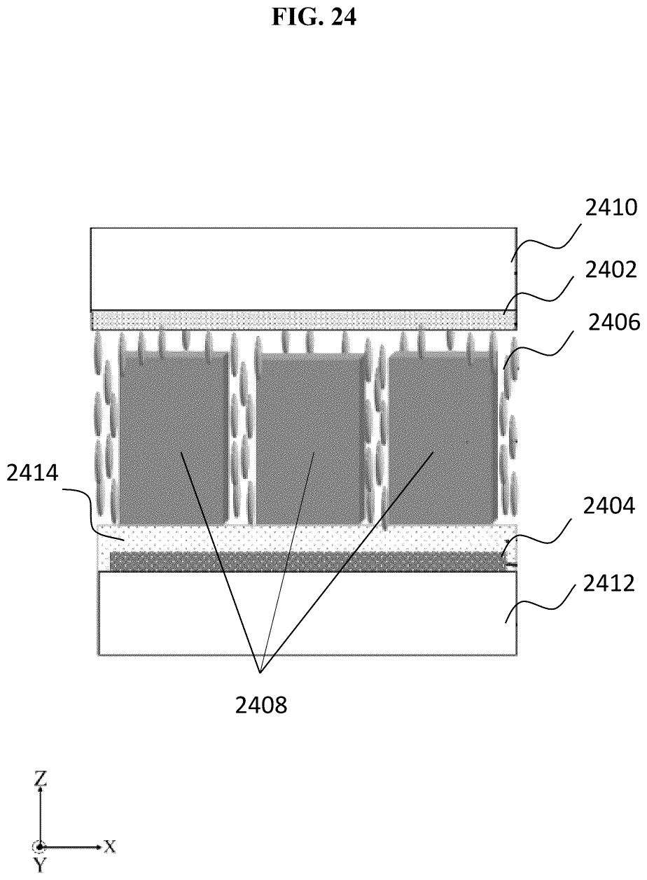

FIG. 24 shows a schematic of a cross-sectional side view of a unit cell of a reflective liquid crystal (LC) device with an array of nanopillars 2408 according to various embodiments. The nanopillars 2408 may be dielectric nanoantennas, and may be included in a liquid crystal layer 2406 between a first electrode 2402 (top transparent electrode) and a second electrode 2404 (pixelated bottom metal electrode). The first electrode 2402 may be in contact with a first substrate 2410, while the second electrode 2404 may be in contact with a second substrate 4312. The LC device may also include a passivation layer 2414 formed on or in contact with the second electrode 2404 such that direct contact between LC molecules with the second electrode 2404 is avoided.

For the nanopillars 2308, 2408 shown in FIGS. 23-24 , the height is the longest dimension. In various embodiments, the nanopillars, 2308, 2408 may include one same material. In various other embodiments, the nanopillars, 2308, 2408 may include a stack of different materials.

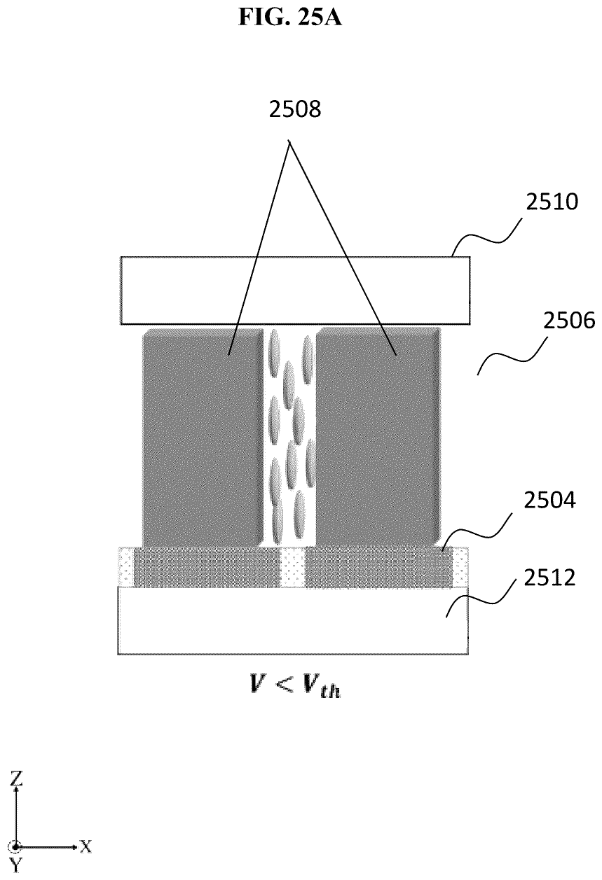

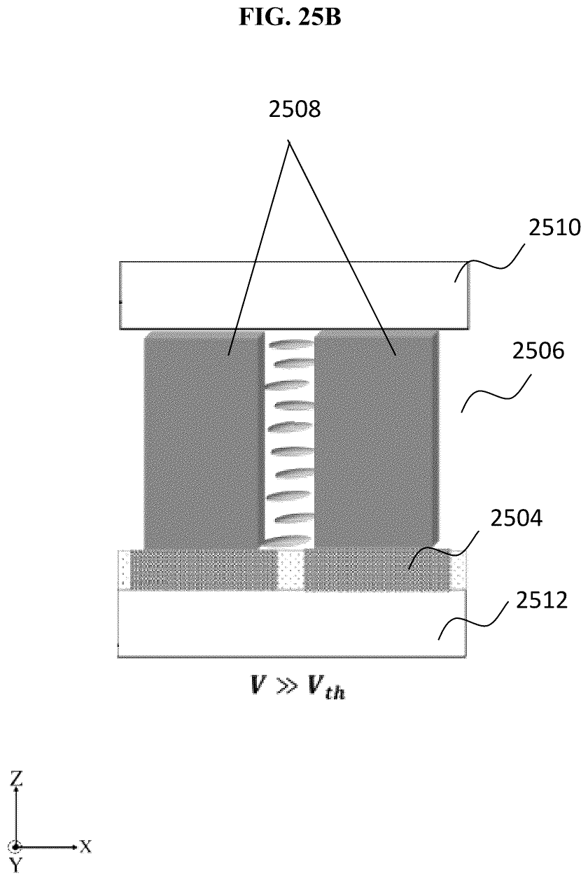

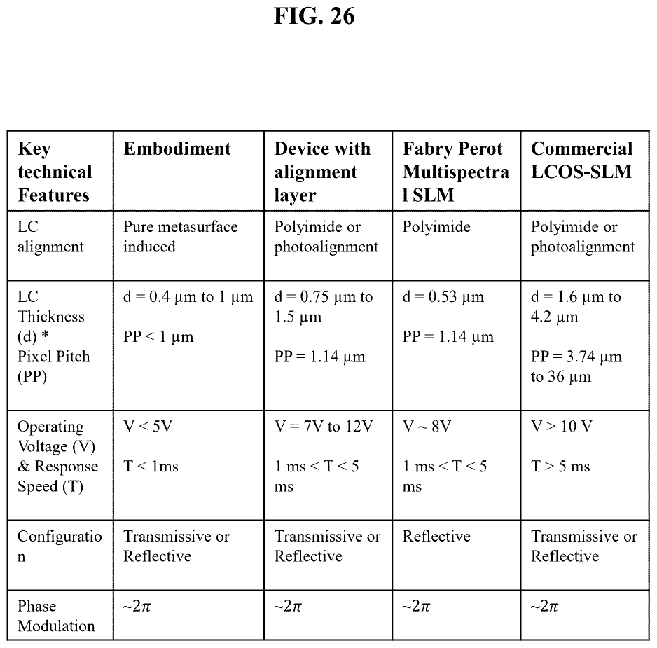

The LC alignment may be vertical in the gaps between the nanopillars. The electrical tuning may be possible either by using negative dielectric anisotropy LC or through the high frequency driving of DFLC. FIGS. 25-26 show switching using positive dielectric anisotropy LC by applying electric field in-plane across the nanopillars. FIG. 25A shows a schematic of a cross-sectional side view of a unit cell of a reflective liquid crystal (LC) device with an array of nanopillars 2508 according to various embodiments when the voltage applied is below the threshold voltage (Vₜₕ). FIG. 25B shows a schematic of a cross-sectional side view of the unit cell of the reflective liquid crystal (LC) device with the array of nanopillars 2508 according to various embodiments when the voltage applied is above the threshold voltage (Vₜₕ). The array of nanopillars 2508 may be included in the liquid crystal layer 2506 and may be in contact with a pixelated electrode 2504. The pixelated electrode 2504 may be in contact with a bottom substrate 2512, while the top substrate 2510 may be in contact with the liquid crystal layer 2506.

Various embodiments may involve using sub-wavelength resonant nanoantennas to create ultra-thin LC cells with uniform LC alignment (without need of any alignment layers) and, simultaneously, means for efficient light and/or wavefront modulation. The electrical tuning of LC refractive index may provide dynamic light modulation by spectral tuning of the nanoantenna resonances. The LC alignment can be efficiently defined (e.g. diagonal, parallel, twisted or vertical) depending upon the aspect ratio and arrangement of the nanoantennas. The efficient dynamic light modulation may be possible by choosing suitable material and driving mechanism. In various embodiments, the nanoantenna geometry define the LC alignment, thereby allow lower switching voltage and faster switching speeds, as compared with LC cells with an alignment layer.

FIG. 26 shows a table comparing the liquid crystal (LC) device according to various embodiments with previous devices that have been reported.

Various embodiments may relate to a LC device in which the metasurface (nanostructures) may provide both light modulation/wavefront modulation and uniform liquid crystal alignment. The nanostructures may be designed for the purpose of sustaining optical resonances that are used for light modulation. The LC molecular alignment may be purely controlled by the periodicity and geometry of the nanoantennas without any additional alignment layer. Compared to conventional LC alignment (using an alignment layer), the metasurface induced alignment may provide pixel size miniaturization, microsecond switching and low voltage driving for LCOS-NSLM devices. Various embodiments without the alignment layer may simplify the device fabrication and may help to improve device lifetime by eliminating the light and heat induced degradation of the alignment layer, therefore improving LC cell quality. Various embodiments may allow for smaller pixel size miniaturization (PP<1 μm), lower voltage driving (V<5V) and/or micro-second switching compared to conventional/commercially available devices. Various embodiments may be a potential candidate for next generation spatial light modulators, with a wide range of applications, including augmented reality (AR), solid-state light detection and ranging (LiDAR), holographic displays and optical communications.

1. A liquid crystal device comprising:
a first electrode;
a second electrode; and
a liquid crystal layer between the first electrode and the second electrode, the liquid crystal layer comprising liquid crystal molecules and an array of nanostructures adapted to cause a desired alignment of the liquid crystal molecules and to modulate light passing through the liquid crystal device,
wherein a periodicity of the array of nanostructures or an aspect ratio of each nanostructure of the array of nanostructures is adapted to cause the desired alignment of the liquid crystal molecules.

2. The liquid crystal device according to claim 1, wherein the first electrode is continuous and the second electrode is pixelated, the array of nanostructures is formed on the first electrode or the second electrode.

3. The liquid crystal device according to claim 2, wherein each pixel of the pixelated second electrode is configured to be addressed individually by an integrated circuit.

4. The liquid crystal device according to claim 1, wherein the liquid crystal layer further comprises a further array of nanostructures, wherein the array of nanostructures and the further array of nanostructures are at opposing sides of the liquid crystal layer.

5. The liquid crystal device according to claim 4, wherein a longitudinal axis of the array of nanostructures is rotated with respect to a longitudinal axis of the further array of nanostructures.

6. The liquid crystal device according to claim 5, wherein the longitudinal axis of the array of nanostructures is substantially perpendicular to the longitudinal axis of the further array of nanostructures.

7. The liquid crystal device according to claim 1, wherein the first electrode and the second electrode are transparent.

8. The liquid crystal device according to claim 1, wherein the first electrode is transparent and the second electrode is reflective.

9. The liquid crystal device according to claim 8, wherein the second electrode comprises an aluminum layer, a gold layer, a silver layer, or a copper layer.

10. The liquid crystal device according to claim 8, wherein the second electrode comprises a dielectric mirror in combination with a transparent electrical conductor.

11. The liquid crystal device according to claim 1, wherein the first electrode comprises an indium titanium oxide (ITO).

12. The liquid crystal device according to claim 1, wherein a thickness of the liquid crystal layer is of any one value selected from a range from 200 nm to 800 nm.

13. The liquid crystal device according to claim 1, wherein the array of nanostructures has at least two dimensions smaller than an operating light wavelength of the liquid crystal device.

14. The liquid crystal device according to claim 1, wherein the array of nanostructures is made of a dielectric material which has a real part of a refractive index being more than or equal to 2, and an imaginary part of the refractive index being less than or equal to 0.1.

15. The liquid crystal device according to claim 1, wherein a dimension along a direction at which the liquid crystal molecules are to be aligned of each nanostructure of the array of nanostructures is larger compared to remaining dimensions of the nanostructure.

16. The liquid crystal device according to claim 1, wherein a periodic lattice of the array of nanostructures comprises a longest lattice vector along a direction at which the liquid crystal molecules are to be aligned.

17. The liquid crystal device according to claim 1, further comprising a passivation layer formed on the second electrode adapted to avoid direct contact of the liquid crystal molecules with the second electrode.

18. The liquid crystal device according to claim 1, wherein the array of nanostructures comprises nanopillars, each of the nanopillars having a height which is larger than its width or its length.

19. The liquid crystal device according to claim 18, wherein the nanopillars are adapted to align the liquid crystal molecules in a direction along a longitudinal axis of the nanopillars.

20. A method of forming a liquid crystal device, the method comprising:
forming a first electrode;
forming a second electrode; and
forming a liquid crystal layer between the first electrode and the second electrode, the liquid crystal layer comprising liquid crystal molecules and an array of nanostructures adapted to cause a desired alignment of the liquid crystal molecules and to modulate light passing through the liquid crystal device,
wherein a periodicity of the array of nanostructures or an aspect ratio of each nanostructure of the array of nanostructures is adapted to cause the desired alignment of the liquid crystal molecules.
